(19) United States
(12) Patent Application Publication
(10) Pub. No.: US 2023/0106019 A1
(43) Pub. Date: Apr. 6, 2023

(54) Variables & Implementations of Solution Automation & Interface Analysis

(71) Applicant: Joni Jezewski, Fremont, CA (US)

(72) Inventor: Joni Jezewski, Fremont, CA (US)

(21) Appl. No.: 17/449,810

(22) Filed: Oct. 3, 2021

(51) Int. Cl. G06F 16/22; G06F 16/242; G06F 16/2458; G06F 17/17

(52) U.S. Cl. CPC G06F 16/2291; G06F 16/2448; G06F 16/2458; G06F 17/17

(57) ABSTRACT

Variables relevant to implementing solution automation & interface analysis determine how different implementations can be found/generated/derived & filtered.

Additionally, additional specific example implementations of components of solution automation & interface analysis (like example solution automation workflows, function types, and useful structures) to implement solution automation & interface analysis are included in the specification of this invention.

### FIELD

Embodiments of the disclosure relate to additional variables of implementations of the inventions “solution automation” & “interface analysis”, as well as example implementation/application methods of variable components like “solution automation workflows” such as “interface queries”, to implement or apply as configuration/data/code.

### BACKGROUND OF THE INVENTION

Variables relevant to components of solution automation & interface analysis, such as solution automation workflows & their variables, fit together in various ways, which are explained further below for clarity.

The example applications & implementations in this disclosure specify configuration/data/code that can be used to apply/implement the inventions referenced in U.S. patent application Ser. Nos. 16/887,411 & 17/016,403. These examples extend the example applications & implementations referenced in U.S. patent application Ser. Nos. 16/887,411, 17/016,403, 17/301,942, 17/304,552, 17/444,286, 17/446,677.

### BRIEF SUMMARY OF THE INVENTION

One or more embodiments of the present disclosure may include a method that involves solution automation & interface analysis implementation variables & components, like:
function types (general functions, interim cross-interface functions, core interaction functions, problem-solving intent functions, interface operation functions, vertex functions), including additional function types like:
useful structure-adjacent functions (like ‘reduce computation’ which is adjacent to problem-solving intents like ‘minimize cost of finding solution’)
useful structure interaction functions (like ‘convert between various useful formats, such as useful problem/solution formats’, like the problem format ‘find a prediction function’ and the solution format ‘regression’)
solution automation workflows & their useful structures (like ‘generative/differentiating variables’) & their implementation variables (like ‘variables of general useful structures’ and ‘interface structures of general useful structures’ and ‘interface structures of specific useful structures like function types’)
general useful structures (like ‘definitely incorrect structures’, ‘adjacent solution structures’, ‘recursive/reflective/interchangeable structures’, ‘alternative structures to random structures’)
variables of implementations of solution automation & interface analysis The examples in this disclosure involve explanations of variables determining how solution automation & interface analysis can be implemented, as well as example implementations or applications of these components.

### BRIEF DESCRIPTION OF THE DRAWINGS

Example embodiments will be described & explained with additional specificity & detail through the use of all of the accompanying drawings in U.S. patent application Ser. Nos. 16/887,411 & 17/016,403, which contain diagrams of the relevant program components (like solution automation module 140) where example implementations contained in this specification can be applied as configuration/data/code. The same applies for U.S. patent application Ser. Nos. 17/301,942 & 17/304,552 & 17/444,286 & 17/446,677, which also offer alternative examples of configuration/data/code of U.S. patent application Ser. Nos. 16/887,411 & 17/016,403.

### DETAILED DESCRIPTION OF THE INVENTION

As used herein, terms used in claims may include the definitions & term usage as detailed in U.S. patent application Ser. Nos. 16/887,411, 17/016,403, 17/301,942, 17/304,552, & 17/444,286, 17/446,677.
The term ‘implement’ a component indicates intent to ‘build’ a component, like ‘implement a function to reverse a sequence’ indicates ‘build a function to reverse a sequence’.
The term ‘apply’ a component indicates intent to ‘use’ a component, like ‘apply interface analysis’ indicates ‘use interface analysis’.
The exception to this is where ‘apply’ is used in the context of the core intent function of the invention called ‘apply’, which refers to a specific invention function that ‘applies’ one component to another, like ‘applying an input to a function’, in the sense of ‘injection’ or ‘fitting/merging’.
These definitions are implied/referenced in the other applications & included to avoid conflation.

### Definitions

workflows: a way to solve a problem automatically
   they are ‘solution finding methods’ to find ‘solutions’, where solutions may themselves be ‘solution-finding methods’ (like ‘regression’ is a solution-finding method, to find specific functions that are solutions to the ‘find a regression function’ or ‘find a representative function’ problems), meaning that any solution-finding method for a particularly standard/useful problem format may be a solution automation workflow (or a component of one, after applying other functions like ‘convert problem to standard problem format’, where that solution-finding method can be applied)
interface query: a way to automatically implement a function (connect inputs/outputs), such as a solution-finding method like a solution automation workflow
   when applied to implement a function intent, the interface query is a function-finding method
   when applied to implement a problem-solving intent, the interface query is a solution-finding method
interface: standardizing filter where any problem can be solved
   why an interface isn't a language: its definition overlaps with the definition of a set, which is a sub-structure found on interfaces and doesn't encapsulate the whole definition of an interface, which is a specific structure in which all problems can be solved, whereas language encompasses all concepts/structures without refinement by a filter that adds value in reducing computations
   why an interface isn't a symmetry: a symmetry is a relevant structure to interfaces (both of which act like a base where certain change types can be applied without losing info), but the definition of a symmetry does not specify how a symmetry interacts with all other structures, including other symmetries, and does not specify how a symmetry can be used to solve all problems, let alone the subset of problems which have been formatted to relevant structures to symmetries, such as ‘change types’
   example of why similarities/differences are insufficient to solve all problems
      many functions have the same or similar ‘similarity to a data set’ as determined by some error metric, but most of these functions will produce sub-optimal predictions in some important case (like with different data samples, or the first set of predictions in high-error areas of the prediction function, while the prediction function is still relevant & reflective of reality), as some predictions are more important than others given the context of the prediction like timing & data set differences
structures like ambiguities/overlaps are sources of info to identify interfaces
   the overlap of ‘difference’ & ‘change’ definitions indicates that they are related variations in a potential field of a unifying concept acting as a symmetry around which changes occur, where the concept may act like a symmetry, but the implications of the relevance of that concept indicate other structures are required to understand & apply the concept, such as how it interacts with other symmetries, whether the symmetry is illusory or real, whether the symmetry has a limit on its lifespan, whether the symmetry is the output of another symmetry
perspective: a filter with priorities (which may be structures, causes, abstract prioritized attributes, or other interface structures) which highlight a structure as particularly important

### Example

a perspective like ‘find the function that minimizes distance from as many points as possible’ produces a solution that can qualify as ‘regression’ to the ‘find a prediction function’ problem
   this perspective can be a function structure, but its still a perspective because its highlighting some objects (distance from points, average) as particularly important
a function like ‘find the function that minimizes distance from the average line’ is a lot closer to the definition of ‘regression’
differences in perspectives:
   the first perspective highlights a specific problem-solving intent to generate a solution-finding method or solution for, which has many possible implementations
   the second perspective highlights an adjacent inevitable solution-finding method, which has very few possible solutions/implementations, given some variance in the definition of the average
perspective variables
   degree of implementation variation
   info captured/created
      perspectives may be useful structures & may contain useful structures (like averages), which capture a lot of uncertainty, complexity or variation/change, providing useful info like a direction to move toward when searching for a solution, or a specific problem-solving intent to fulfill
adjacence to solutions/solution-finding methods
definitions
priorities
filters
useful structures referenced
problems the perspective is useful for
relation to other perspectives
   differences in perspectives can be used to generate other useful perspectives, and identify which perspectives would be most useful to guide a problem-solving workflow or interface query, given perspective attributes like implementation variation
perspective structure (interface, function, priority set, etc)
   a perspective may be formatted like a particular interface structure, like a function or interface, while still qualifying as a perspective be it prioritizes some objects over others
   abstraction (abstract perspective or a specific perspective)
how is a perspective different from other structures?
   its definition overlaps with an interface, but the interface includes an abstract concept like ‘cause’ that is prioritized & focused on, and all the structures relevant to it, & standardizes everything to that concept's structures, whereas a perspective may just focus on a particular set of structures rather than changing structures (for instance to be formatted in terms of causal structures like dependencies on the cause interface, rather than their original format, whereas a perspective may just focus on causal relationships or filter out anything that is not causative)
how is a perspective like ‘find a function minimizing distance from average line’ different from a function?
   a perspective can be formatted as another structure than its standard structure (a filter with priorities), because other structures can have default priorities & act like a filter
how is a perspective like ‘find a function minimizing distance from average line’ different from an interface query?
   an interface query may also produce a step with an intent like ‘find a function fulfilling x’ but in the context of the interface query, the intent of this step is to fulfill another intent, like a problem-solving intent such as ‘create a function to fulfill y automatically’, which may involve solving the sub-problem of ‘finding a function to fulfill x’
   this doesn't contradict the definition of the interface query or perspective, something can be both without violating either definition
the reason to call something a perspective is if it highlights a priority or prioritized structure in a way that adds value by filtering out other structures, and filtering is a very useful function that is frequently used in other problem-solving processes, like the problem-solving intent ‘filter the solution space’ or any call to the ‘find’ or ‘identify’ functions

additional structures that can be applied as useful structures in objects like solution automation workflows, with associated usage intents
mixed abstract/specific structures, for ‘apply’ and ‘connect’ intents
specific standard problem formats (‘find a prediction function’, ‘sorting algorithm’) that any problem can be converted into
position relative to other objects of the same or a similar type
useful structures applied to functions (function interaction levels & function types & function-differentiating functions)
interchangeable structures that can be used to generate each other
problem/solution structures (problem-solving intents, solution components, solution metrics, solution workflows)
solution-determining/adjacent structures (making the solution trivial)
causes of interface structures (intents, changes, differences), for ‘predict’ intents
perspectives that make solving a problem quicker with alternate priorities
core structures, for ‘build’ intents
additional alternatives to ‘random’ selections (useful for ‘filtering the solution space’)
   maximally different examples
   unique examples
   type examples
   examples with no high-variance points in between examples
   representative examples
   examples of each ‘change type’ combination (change types like adjacent change, opposite change, extreme change, standard change)
   examples of limits on change types
   examples of specific difference types, like opposites or contradictions or position/direction differences
   examples of specific interaction types, like intersections or alignments
recursive structures, useful as a structure to generate change types creating complexity
   rather than a network of nodes where input-output sequences can connect nodes, a network of input-output sequences where input-output sequences (like various traversals of a function logic tree) can connect input-output sequences, and adjacence indicates interactivity
the meaning of meaning structures like ‘lack of understanding’
   meaning of a prediction function, given an understanding & definition of meaning indicated by the meaning-evaluation function defined & applied at the time
ml applied to predict:
   generative function of prediction function
   weight changes that will optimize the most quickly
   prediction functions of various algorithms/parameters/data sets/assumptions to select most useful prediction functions minimizing a solution metric
definitely incorrect structures can be useful for some purpose be the inputs/outputs are similar or the similarities are relevant enough for the usage intent

### Example

approximation functions are by definition incorrect but are still useful when an approximate solution fulfills solution metrics
additional structure formats
formatting a specific/different structure as a set of vectors applied to a standard structure
‘reflectiveness’ of a structure as an organizing attribute (what other structures can it reveal/identify, adjacently become or build or interact with, what can it filter out or emphasize/prioritize)
function types
   existing function types referenced in other patents include:
      general functions (‘find’, ‘build’, ‘derive’, ‘apply’), core interaction functions (‘connect’, ‘reduce’, ‘filter’), problem-solving intent functions (‘filter solution space’, ‘solve related problem’), interim cross-interface interaction functions (‘find a structure in a structure’), interim interaction level functions (‘organize’, ‘standardize’), functions implementing useful structures like ‘trade-offs’, & interface operation functions like ‘combine interfaces’
additional function types include:
   interaction functions of useful structures (like ‘convert between various useful problem/solution formats’ such as converting between problem formats like ‘reduce input variables’ and ‘find prediction function for input variables’, or converting between solution formats like ‘function to find y-value given x-value or adjacent y-values’, or ‘prediction function-finding function’)
   useful structure-adjacent functions (like functions adjacent to ‘problem-solving intents’), like how ‘reduce computation’ is an adjacent function to ‘minimize steps to connect problem/solution’, but doesn't specifically interact with problem/solution structures.
applying ‘simplifying variables’ results in selecting ‘high info-capturing simple variables’ (like type variables or composable unit components or similarities) more frequently, given that agent decisions are often shaped by ‘simplifying variables’ as well, so ‘simplifying variables’ act like a highly interactive interface where many changes occur around the variables as a base for those changes, and standardizing to the interfaces represented by those variables captures a high amount of info
   these simplifying variables are useful structures that can be applied as sub-interfaces (as opposed to primary interfaces) where many problems can be solved, even though all problems cant be solved with these useful structures
applying the origin problem as a stability structure (such as an average/representation structure around which change occurs, or as a minima structure where a system stabilizes), given that problems generally occur on their own as a result of bad planning/lack of understanding, and differences (in the form of energy/work) are required to solve the problem
applying regression/line-fitting & related solution-finding/specifying methods to find lines that better fit the data set than the standard regression line, which is the problem be of the error definition as ‘mean squared difference from the regression line’ or a similar definition incentivizing a solution that minimize that error
applying problem states as minima, and surrounding states of minima as adjacent states that are not definitely problem states, and known solutions as maxima of relative height
   where equivalent states created by applying changes to solutions/problems can act like neutral starting points for other solutions with less defined solution structures, and where areas between different problems are possible overlapping solutions to multiple problems

examples of possible alternate implementation strategies & paths connecting different versions of the implementation of solution automation & interface analysis
implementation variables
what structures are positioned as which automation structures (constants/variables, input/origin & output/target structures, code/data/configuration/docs/examples, context, components, functions, systems & usages)
which formats are applied (vectors, functions, networks, function/variable/component networks, mixed structures, etc)
which functionality is hard-coded or found/generated/derived
   which variables differentiate functionality, such as:
      abstraction level, variation in input/outputs, structures like changes/differences, filters, or trees/networks/sequences fulfilled, interface structures found/derived/generated/applied, fit/relation to other functions, composability, uniqueness, intent, solution metrics, lifespan, position in function structures like usage stacks/sequences
optimization/update strategy (whether functions can be changed/parameterized automatically or not)
perspective: which structures to prioritize and which structures to start automating, where the perspective answers questions such as:
   whether to prioritize automating the most generative structures first (like the interface-query design logic) or most composable structures first (like general functions such as find/build/derive functions or highly structural core functions like connect/reduce/filter, whether to automate useful structures first, whether to create constant configuration first, like definition routes of important concepts & interfaces, whether to start by automating application of the logic to a unit example or with a set of known example inputs/outputs
   which structures (constants/functions) are required by a particular implementation & which are optional
   which structures are particularly useful for an implementation
   whether to apply default/standard structures as a base (such as ‘standard interface queries’), or to apply other solution automation workflows to generate implementation logic
implementation examples:
   creating space structures out of core structure (like ‘difference’) having varying structure (‘difference’) types, so interface queries can be implemented for example by selecting a ‘difference network’ to compare structures on (like interface structure differences, like input/output, value, definition, structure (sequence/position/path), interaction structure (like ‘connection/change type’) differences’)
   creating the set of useful functions of the referenced function types (general, core interaction, problem-solving intent, interim functions, interface structure functions, problem-function functions, commonly useful interface functions, function-connecting functions, etc), and adding any new functions required, to use as possible interface query steps or workflow components
   storing useful interface queries & other problem-solving structures that typically produce solutions in configuration & iterating through those according to similarity of problem to the problems associated with those solutions
   for example, using the interface query to ‘apply useful structures by default as a problem-solving or solution component/input’ by default, & iterating through other interface queries like those implementing “formatting problems in more solvable problem structures like ‘find a prediction function’ & applying known solutions” based on success probability, either for problems in general or for similar problems
   implementing interface queries & other problem-solving structures by applying similarities to configured interface queries & structures where they are similar, and applying variables & associated differences where they differ, rather than designing specific interface queries for each new problem with interface query design logic
   a sorting function to sort structures in a problem space as either problem/solution structures & apply useful function types based on their classification
   apply ‘useful structure map applied to a problem space’ to find likely useful structures in a problem space

example of how various perspectives (like ‘what future opportunities are invalidated by a decision’), interaction levels (like ‘comparison to related alternative objects’), cross-interface structures (like ‘state changes’) & specific interface structures (attributes like ‘reusability’ or ‘organization’) offer useful info to making decisions about how to solve problems in complex systems
some of this info overlaps across various structures, and some structures are more useful than others, and some structures can be combined to create the usefulness of other structures
some of these perspectives can be combined to replace the functionality of the others
these interfaces provide different structures to understand the system with, but its not immediately obvious which interface is most useful to understand a system
often the problems with combination interfaces is that there are structures of recursion, self-reference, loops, & ambiguities that make a difference type unclear

### Example

the concept of probability may occur in a language network, and the concept may appear elsewhere in the network, such as ‘probability of co-occurrence or similarity determined by position’
   the ‘attributes’ of ‘attribute’ may occur in a network of ‘attributes’, where the concept of ‘attribute’ appears in these structures on the network but is not explicitly defined on the network
this overlap may not cause a semantic problem, but it often does, mostly in the confusion (non-explicit connection/mapping) between different interface combinations
how do you filter these useful structures to find the most useful structures to focus on when solving problems in these systems
for example, how do you identify ‘incentives’ and ‘cooperation’ as particularly useful structures in agent-based systems:
   ‘incentives’ are structures that simplify most other structures & ‘cooperation’ is a structure that simplifies the function of ‘fulfilling intents’ by ‘distributing/sharing costs like responsibility to share inputs like information and share benefits’, which is particularly useful be benefit/cost is a core structure in agent-based games
   so these are useful structures by default, but they also decompose & standardize other useful structures into simpler structures that align with the core structures of the complex system, allowing efficient comparisons between alternate routes between states (like different positions or different resources)—in other words, they are a useful ‘reducing structure’ or ‘simplifying structure’, ‘reduce’ and ‘simplify’ being core interaction functions & interim functions enabling interactions between problems/solutions, so having structures that fulfill those ‘reduce’ or ‘simplify’ functions that are useful for problem-solving is useful by definition
you can filter these structures by which structures fulfill useful intents like ‘reduce’ or ‘simplify’ for other useful structures
   like how ‘incentives’ simplifies other useful structures like ‘a system of games’
when understanding a system of agents, do you think in terms of the following interfaces & interface combinations
   physical agent system
   functions, like thinking or communication & other interaction functions
   traversals of the paths of the system & the inputs/outputs of these path traversals
   attributes like cost & the attribute network connecting them
   system structures like incentives/games
   a system of games
   a set of possible state changes for an agent, or for the system, or for functions
   probabilities of actions given system info
   probabilities of games, functions, or path traversal in the system
another example is in automation design—do you think in terms of:
   application logic
   existing functions & necessary changes
   cross-abstraction level impact
   how to convert everything into configuration (or code in the form of a function/script/template/document)
   which functional position/structure a change should occur in
   impact on the business
   technical debt & possible errors introduced by the required change
   whether the change is actually required, and the related priority & demand for the task
   whether alternatives or an existing solution exists
   whether the solution is testable in the timeframe allowed
   the opportunity cost of building it vs. building something else
   whether it can be re-used or abstracted
   whether it fits into an existing system or requires its own
   whether assumptions are correct or need clarification/evaluation before building
   whether an upcoming planned feature release of a tool will fulfill the task
   whether default/adjacent implementations of the task run into known vulnerabilities or limitations of the tech stack
another example is in neural network design:
   existing algorithms & parameters & relevance based on input/output data types & value patterns
   whether a new network is necessary to find the prediction function or if an existing trained model will find it
how to preprocess the data to reduce the work the network has to perform to connect inputs/outputs
whether an adjacent optimal can be reached by changing existing algorithms/parameters
whether a logic function network would be sufficient to map inputs/outputs (explicit if/then statements or functions with non-mathematical inputs/outputs)
whether the network can capture the complexity of the input-output connection function
whether an approximate prediction function is sufficient
how to update the function
how to generalize & create variations of the function
how to remove bias in various positions (in data or in the network or in the model)
the limits on the relevance of the prediction function (time limits, scope/scale limits, interaction limits, topic limits, data limits)
when governing:
   conflict minimization
   cost minimization (responsibility, cost)
      delegation of responsibility
      budget balancing/avoidance of debt
   power maintenance
   rule compliance
   unification & unified group size maintenance/increase
   representation
   diversity of inputs
   avoidance of enabling/permitting crimes
   organization
   enforceability of laws
   manageability of solutions/tech
   relative success compared to other forms of government

example of how to use interface analysis to identify that the ‘bias vs. variance trade-off’ can be resolved with ‘conditional’ or ‘alternate’ or ‘subset’ structures, assigned to data ‘subsets’ based on data point attributes (like change type cause/patterns & type of a data point)
minimizing variance
   intends to predict as many points as possible in a data subset
   outputs a specific function for a data subset
   has errors when applied to different data subsets
minimizing bias
   intends to predict as many data subsets as possible with minimal error, rather than specific points
   outputs a general function for many different data subsets
   has errors for each data subset, but fewer errors across many different data subsets
functions can be assigned to predict data points with attributes (like a range of standard deviation) based on the cause & patterns of their differences
   if the cause of a data point is likely to be randomness, it can be excluded from functions that don't include randomness as an input
   if the type of a data point differs from other data points predicted by a function, it should be predicted by another function that predicts that type
this solution involves re-arranging data subsets so they can be better predicted by functions

examples of when a generally useful structure like an ‘input/output sequence’ is not useful for a specific problem
in most cases, you can use an input/output sequence, like when you have the inputs/outputs of functions indexed, so outputs can be routed to functions with matching inputs to create a sequence connecting problem/solution, but this doesn't work without other interface structures when:
   when you don't have inputs/outputs indexed
   when you have inputs/outputs indexed, but there are no functions to connect inputs/outputs in part or all of the sequence between problem/solution, so other methods like pattern/logic interface functions are necessary to fill in the gaps in the sequence left by missing or non-indexed functions
   the ‘derive’ function can be fulfilled in various ways
      the logic interface can infer connections that are implied, or find another route to connect problem/solution than a route requiring a missing function
      the pattern interface can infer connections according to common patterns & probabilities
      the ‘build’ function can construct missing functions out of available functions/structures
      these alternate interfaces fulfill the ‘input-output sequence’ with a variable definition of ‘connection’ applied to ‘inputs/outputs’, where there is flexibility added to the degree of certainty in matching & connecting components of the sequence, resulting in a partial implementation of the input-output sequence that may be resolved into a more certain structure with more information, similar to a function with some certain/constant one-line sections and some conditional/variable multi-line sections
   when there is a more effective/adjacent/useful workflow/query that solves the problem than the ‘find input-output sequence’ interface query fulfilling the ‘connect problem/solution’ solution automation workflow
      finding other useful structures, like ‘finding required functions’, ‘finding general interaction structures’ (rather than specific interaction structures like input/output sequences), or ‘finding useful reductive filters’, may be a more effective or efficient query than ‘find an input-output sequence’, depending on available & adjacent info
         other interaction structures include:
         ‘completion’ or ‘combination’ structures, where structures fit together to form a component
         ‘integration’ structures where structures are merged to create another more useful structure
         ‘variable’ or ‘type’ structures, where one structure is a variant of another with different parameters
         so useful alternatives to input/output sequences include:
         ‘combination sequences/sorts/trees/networks’ to create combinations of structures that produce useful components (like creating a ‘shape’ out of components such as ‘defining attributes like boundary lines’)
         rather than using input-output sequences to solve a:
         ‘find an optimal route’ problem, combinations of interaction structures like ‘route sequences’ or ‘difference structures of sub-optimal routes’ can be used
         ‘find a prediction function’ problem, combinations of structures like ‘subset functions’ or ‘conditional functions’ or ‘base functions & conversion functions’ can be used
         ‘integration sequences/sorts/trees/networks’ to create merged structures that are useful (like creating a ‘type’ definition out of ‘two examples’)
         rather than using input-output sequences to solve a:
         ‘find an optimal route’ problem, integration structures like ‘integrations of route filters like differences from sub-optimal routes and definitions of benefit/cost of movement’ can be used
         ‘find a prediction function’ problem, integration structures like ‘weighted averages of alternative functions found with varying regression metrics’ can be used
      ‘variable sequences/sorts/trees/networks’ to create changes to a standard/base/origin structure that are useful (like creating an ‘example’ out of a ‘type’ definition)
         rather than using input-output sequences to solve a:
         ‘find an optimal route’ problem, ‘change structures’ can be applied to a standard sub-optimal route
         ‘find a prediction function’ problem, ‘change structures’ can be applied to a standard sub-optimal prediction function
   the reason there are other useful structures is bc there are other solution automation workflows than ‘connect a problem/solution’, with associated useful structures for the workflow, bc there are other core structures than inputs/outputs and sequences
      ‘combination’ structures go with the workflow ‘build a structure out of components to solve a problem’
      ‘integration’ structures go with the workflow ‘break a problem into sub-problems and merge sub-solutions’
      ‘variable’ structures go with the workflow ‘adjust an existing standard solution until it fits the problem, according to its differences from the standard problem, like different solution metrics’
   this means solution automation workflows can be derived from these core structures & interface structures applied to these core structures
interim interface queries can be used to connect a workflow with a solution-producing interface query
   ‘find an input/output sequence of useful structures fulfilling this workflow’ can be an interface query used to determine if a particular workflow has a useful structure input/output sequence available, and if not other interface queries can be applied
a variation of ‘interim interface queries’ is ‘interface queries for interface queries to fulfill/implement a workflow’
   ‘interface queries’ are ‘queries for structures/functions to fulfill an intent’ so they can be plugged in wherever there's a lack of info (problem to solve)
   problems to solve can include:
      ‘find an interface query to solve the problem of finding an interface query’
   where solution automation workflows are applied to solve the problem, such as:
      ‘connect a problem (solution automation workflow requiring an interface query to implement it) with a solution (an interface query to implement it)’

example of applying an interface query like: ‘apply the definition structure from the core interface to find requirements of the solution, then find structures fulfilling requirements of the solution when merged’
apply relevant components of the ‘randomness’ concept definition like ‘probability’ to generate a function to identify ‘randomness’
   lack of structure/patterns: as ‘adjacent number sets’ continue to follow a pattern (like a ‘repetition of the same number’), a sequence has increasingly lower probability of being random, which can be used as an ‘approximation’ structure of ‘randomness’
   relative usefulness for intents associated with the structure: another example structure that can approximate randomness is whether a particular sequence acts like a good random number generator if numbers are selected with a certain hard-coded pattern (no matter what pattern/structure is applied in selecting numbers from the sequence, they should still have a random distribution, where all possible outcomes approach equality in probability)
   adjacence to opposite (non-random) structure: another example structure that can identify randomness, is the number of conversions that need to be applied to a sequence to change it into a less random structure (how many substitutions/multiplications or other operations need to be applied at what scale/interval or other structure, to make the sequence definitively non-random—a random sequence will have a higher number of required operations than a non-random sequence)
examples of useful math-structure connections
   a network where nodes are organized by similarity applies geometry by applying the ‘distance’ shape to the network to represent the concept of ‘similarity’
   a ‘structure with one piece missing’ is a geometric shape of ‘obviousness’ or ‘implication’ where completing the shape is a default & trivial operation
   a shape with corners is useful for depicting various change types producing maximally different points
      these ‘maximally different points’ can represent various structures (like types, points that act like averages/symmetries, or points where stabilities are reached)
      a square can represent maximally different types be the changes between corners of the square are orthogonal
      a hexagon can represent partially overlapping/connecting change types because changes between corners are not isolated/independent
   difference between representing info as values vs. types vs. differences vs. networks/trees/set vs. changes vs. functions
   values are a good origin point for starting with the most information about a structure & removing/changing it in ways to focus on other attributes
   differences are a good structure for quick identification/filtering
      networks/trees/sets/types are useful difference structures
      types are specifically good at encapsulating which variables a structure has, if not the exact values of those variables (a good ‘representation’ structure, like an ‘average’ is), so they are useful as representation structures to evaluate type statistics like membership count and variability within a type
   changes are useful at representing time-based differences & time in general, such as the time required to convert one structure into another (adjacency, computational complexity)
      functions are a change unit
      the same set of changes can be connected with different change units (functions)
      functions can be formatted as various structures
         the concept of ‘exponent’ applied to the concept of a ‘function’:
         A function of functions:
         A function applied to itself, a function applied to another function
         a ‘structure’ of functions:
         A list of sequentially applied functions, a tree/network of functions, a set of functions (given their possible interactions, which can only produce the function), a set of nested/embedded/contained functions
         ‘functions’ as ‘input value changes’
         A matrix of values representing the changes applied by the function
         functions as ‘differences from other structures’
         differences from a standard/successful/base/unit/incorrect function
         ‘not the opposite function’ & ‘not a similar function’ (except in any equalizing contexts where they have the same input/output)
         the difference between a ‘function applied to another function’, and the ‘function applied to itself’, given the ‘differences between the other function & itself’
         the difference in attributes (area, generative functions, tangent bundles) between a function & another function
         functions as combinations of standard logic operations like ‘or’ creating a logic tree linking values logically
         ‘y value 1, given x is value 1 or value 2 or value 3’

examples of applying interface analysis to find/derive/generate useful math formats
traveling salesman:
   apply the useful structures of ‘components’, ‘interactivity’, & ‘adjacence’ structures to find interactions between points that form components that form a set (having unique components) with other components, where the component interactions also optimize for ‘nearest neighbor’ distance solution metric in the points connecting the components
   components being “sets of points that locally form components optimizing for ‘nearest neighbor’” (minimizing the ‘distance’ solution metric)
   this applies the ‘break a problem into sub-problems and merge sub-solutions into solution’ solution automation workflow
https://math.stackexchange.com/questions/733754/visually-stunning-math-concepts-which-are-easy-to-explain
for the power of 2 sequence with the square visual
   why ‘adjacent rotation of a half of the current area’ would produce an equivalence between the ‘length’ of the ‘emerging sides of the shape’ (producing a square instead of a rectangle, as square sides as equivalent) and why it would be produced by a power of 2 (each subsequent term is half the area of the previous term)
   bc each adjacent rotation of half the current area produces an overlap leading to a set of three equivalent squares (½ and ¼ overlap to produce three squares equal to ¼, meaning 3 squares of ¼ area, totaling to ¾)
   so the adjacent rotation doesn't produce a difference, but rather a symmetry based on the middle square where they overlap (leading to an equivalence on both sides of the middle square, meaning there are two protrusions rather than one which is how it starts with the first term, as a rectangle of ½ equal to two stacked squares of ¼ area), and if change continues in the direction linking each ‘middle square’ symmetry, another symmetry is produced pointing in the diagonal direction toward the corner of the square, and the limit of the sequence's potential to add more area aligns with the intersection of the emerging sides that create the corner
   in summary, the ‘overlap’ creating the ‘symmetries’, and the ‘alignment’ creating a ‘corner’ (‘alignment’ between ‘emerging sides’, their ‘intersection’ & the ‘limit’ of the ‘sequence’), and the ‘adjacent rotation’ creating the ‘overlap’ and its ‘symmetries’ are the structures necessary to resolve/predict the interactions between these structures
   same for the example with (odd sum of n integers)=n\hat{ }2
for the area of a circle problem, the signal of the relevant basic formula for circumference being 2*pi r should indicate that there is a reason why the pi*r is repeated (hence the 2 as a constant), which occurs in many shapes, including sides of a rectangle
   formatting pi*r as the sides of a rectangle leaves one unknown, the length of the other side, and trying out ‘r’ is an adjacent move
   this fulfills known formulas & is verifiable, and provides another format for the area of a circle that is more calculable and also adjacently connectible to the original shape & its relevant known variable interactions
      ‘connecting the formats’ of a circle with a rectangle can be done with the
         ‘rearrangement of circle partitions created by arcs’ as shown in the diagram at the link, in which the arcs get progressively more linear as the arc lengths get shorter
         the ‘adjacent positioning of unrolled progressively larger circles’, forming a ‘structural similarity’ between the ‘increasing third side of a triangle from 0 to the remaining endpoint’, and the ‘increasing lengths of the unrolled lines of progressively larger circles’, the area of the triangle being easier to calculate & visualize & prove
         identifying ‘progressively larger circles’ as useful for connecting a circle with a triangle requires:
         Applying ‘adjacent transforms’ to the given ‘circle’ shape to an ‘extreme’ value of zero, keeping the ‘origin position’ parameter the same
         identifying the ‘adjacent transform’ of circle boundaries into lines (with unrolling operation)
         identifying the ‘structural similarity’ between increasing lines and the third side of a right triangle increasing from zero to the remaining endpoint
         this converts:
         A circle=>vary shape to extreme value with same origin position=>multiple circles of varying size=>unroll=>multiple lines of varying length=>sort=>multiple components of triangle area=>triangle area
         additional methods can produce this connection between circle/rectangle formats:
         Apply ‘default’ interface to the ‘change’ interface
         Another way to arrive at this format to display area of a circle in a simpler (& therefore more calculable/verifiable) is arranging the known formula for the area in a way that doesn't have pi as a side length
         the ‘few only options’ for formatting the known area formula as a ‘simpler shape’ like a rectangle are pi*(02) or (pi*r)*r, so this visualization is one of the ‘default’ options (if you assume or are given that the rectangle is the simplest possible ‘format’ for the area)
         apply ‘definition’ interface
         the ‘rectangle’ is also an ‘overlap’ with the ‘unit’ ‘definition’ of area (x*y, or ‘x columns of rows with length y’) so it doesn't need to be guessed at as a relevant shape
         the interaction rule ‘if you align lines by their endpoints, they create a shape with area’ is also the ‘definition’ of multiplication, applied at an ‘extreme’ value for one of the multiplier parameters (a line having zero area)
         so by applying the ‘definitions’ of ‘area’ (and its relevant objects like ‘multiplication’ & ‘rectangles’), you can derive a way to connect the circle & rectangle formats
         ‘function input-output sequence’:
         this can also be reached with an ‘input-output sequence’ query, which queries for functions with the ‘attribute’ of linearity as an ‘output’, and functions that take pieces or adjacent transforms of a circle as ‘input’
         this connects the attributes of the circle (as a set of shapes produced by arcs) with a ‘linear emergent border’ structure that happens to be a set of horizontal/vertical lines
         curvature & center=>completeness & alignment at origin/corner & curvature=>separation/partiality & alignment at vertically straightened tops & linearity=>emergence of vertical & horizontal borders (of aligned shapes forming a rectangle)
         ‘structural similarity between inputs/outputs’:
         this can also be reached with a query for combining triangles into rectangles (two triangles make a rectangle), since the pieces of the circle created with arcs resemble triangles with an extreme arc length parameter value
         given the ‘structural similarity’ of ‘triangles’ and the ‘shapes of a circle produced with arcs with extremely short lengths’, and the ‘structural similarity’ between ‘triangles’ and ‘area’, apply interaction rules of ‘triangles’ and ‘area’ (such as ‘two triangles having side lengths in common, positioned adjacently with a common side, create a rectangle’)
         this connects the structures:
         ‘circle’=>‘shape produced by arcs’=>‘triangle’=>‘rectangle’ (simpler output format for visualizing area of a circle, starting from the circle, to prove area formula visually)
         this can also be reached using structural similarities between curvature-area interaction rules, like those determining area under a curve, specifically those determining area under a sin/cos wave function, the change patterns of areas of triangles created between a circle's origin and its boundary, the change patterns of areas when a circle is distorted according to wave patterns, etc
         ‘generative functions’:
         Apply ‘difference’ structure of the ‘change’ interface
         the ‘difference’ between how a circle is generated from a line and how a rectangle is generated from a line is just a ‘fixed endpoint’ of the line as its shifted, so these formats can be connected by reducing/converting/removing that difference
         this can also be reached with the generative formula for a circle using a rotation of a line:
         the line is a unit of a rectangle, so aligning the pieces of the circle created at each state of the line during its rotation using a different alignment than the common central point uniting the lines' endpoints (a vertical alignment of line endpoints) can also be used to generate the rectangle from the circle
         given the interaction rule of the line as a generative input to the circle, we can determine (rather than guessing as with the triangle) that the line is closely related to the circle, and ‘interaction rules of lines & area’ can be applied to represent the shapes that lines adjacently generate, which includes circles)
         interaction rules of lines & area include ‘if you align lines by their endpoints, they create a shape with area’

example of applying interface structures to solution structures such as ‘neural networks’ in the ‘find a prediction function’ problem space to optimize/adapt a ‘neural network’ solution format
apply structures of variable & error structures to neural network algorithms/params to speed up convergence without losing possible minor change contributions (that are important for edge cases or important when aggregated with other minor change contributions)
   randomly missing structures (weight values, node propagations)
   randomly embedded node sub-layers of a node or node splitting when a node is more influential
      randomly multiple varied similar weight outputs of a particular node to over-prioritize that node
   randomly de/re-activated nodes & node structures
   randomly apply maximizing, standardizing, or randomizing function to weights
these can be applied when a node is about to be or has recently been deactivated, to check for edge cases
   ‘would this change have been caught earlier if these nodes hadnt been deactivated’
these can also be applied in structures of other structures
   identify functions on different interaction layers:
      solution metric/cost optimizing and node/weight unit interactions functions:
         convergence-speeding, skippable, neutralizing, redundancy-creating, difference-maximizing weights for a particular layer (as opposed to one weight)
apply ‘predictions’ to weight updates to skip more predictable weight updates (once a pattern of changes is identified in weight state changes) & advance to a later stage, by:
   splitting the node into multiple possible values for the weight/node combination unit that are very different, be its unlikely that one variable is a high predictor in the real world, so its likely that a particularly important variable is more complex than other variables (like a type or other aggregate variable) and can be split into multiple factors or parameters
   splitting the possible weight combinations into the most unique weight subsets that indicate a specific/unique point/range on the weight:error space, and initialize weights at those very unique subsets in various parts of the network to filter out point/range weight possibilities quickly
   isolating the function subsets that would determine the rest of the function (points at regular intervals, subsets where change types are likely to interact/aggregate) and predict those function subsets
neural nets should have a target structure (like a target ‘variable interaction structure’ such as ‘attribute-type convergence’) based on understanding of variable interaction probabilities & other useful structures that their emergent structures comply with and that their structures can optimize for extracting from versions of input data, deriving the neural network structure from this target structure & filtering it based on the emergent structures that would optimize info extraction from input data versions
data preprocessing applies ‘functions of inputs’ as ‘neural network inputs’
   the progression of state sequences between original inputs & the functions of those inputs fed into the network can be mapped to the changes in optimal network parameters that take place at each step in the sequence, to find the optimal parameters likely for the network once x operations to preprocess the data have been applied
   other than applying ‘functions of inputs’ as ‘neural network inputs’, other structures can be applied as ‘neural network inputs’
      generative functions of inputs
      the interaction space of inputs (possible/probable outputs, like errors)
      processing function sequences (since inputs/outputs may be less useful than the functions used to connect them), as a way of finding other functions to apply to input data
         generative functions of processing function sequences
weight/node/activation units make emergent structures like functionality probable & possible in a neural network
   identify all the emergent functionality/attributes/structures in a neural network with different input variations & parameters
   identify how these structures could interact (coordinate, align, or neutralize each other) to create other interaction levels of emergent structures
   identify how these various interaction levels & the interaction structures defined on them as possible/probable would create possible/probable solution/error structures
      avoiding error structures like ‘too many differences in outputs of nodes with similar input info (feature) or similar potential info (info required to identify a feature)’
   identify how these structures can be optimized to avoid error structures or prioritize solution structures
      like ‘prioritize applying weights to connect nodes to create a particular similarity/difference type’
apply useful structures like optimizations to various functions of the network & its processing functions, using workflows that use an answer/solution once a standard solution is known
   more efficient weight paths & weight values to reverse-engineer a network that would have found the answer sooner
      more efficient networks/weight updates can be found to reverse-engineer a weight-update algorithm or a network structure/parameter that would have sped up learning or used less info or produced higher accuracy
      from this, a reason why its more efficient (‘solution success cause’) can be derived, like it includes info that was missed in the original network be of activation threshold config, or integrates the concepts driving feature importance like adjacence depending on the data type
   the domain of the data type can be derived by which changes produce higher accuracy
      if adjacence determines interactivity/relevance & combinations of adjacent features improve accuracy, the data is likely to be a graph or image of a system
         inferring domain allows other rules/structures to be integrated
         once you know its a visualization of a system, you can look for nodes/components of the system & other system objects & apply system interaction rules
   find useful structures like symmetries in correct/high-impact weight paths & average/central/ambiguous correct/high-impact weight values around which other correct values vacillate is a first step to connecting raw numerical data with the meaning interface
applying interface structures to optimize a particular neural network function, like to generate useful variants of ‘gradient descent’:
   checking if a hyperplane intersects with a peak in lower dimensional space that reduces common points to one point (the set of x combinations that result in the same y, where the set of x combinations would be one point)
   checking for a horizontal plane's intersection count/area as its moved between low/high y-values to find spaces between intersection areas likely to have minima
other error definition structures
   prediction accuracy should reflect ability of info to predict output (only so much accuracy can be produced from info, without using other methods)—if its more predictive than what the info can predict, there's an error in the data/network/params/functions

example of deriving the best explanation for a complex connection structure (like a neural network) by applying useful interface structures
identify an example in the form of the simplest specific solution format sequence between input/output, with structures indicating:
   structures representing the most unique information possible, to reduce structures required to visualize (if its a large network, this means indicating the inputs/outputs of as few node layers as is necessary to explain the functionality, cause, intent, etc)
   relevant differences (structures indicating different activated nodes, different functions/weights/node types)
   generate ‘opposite/difference’ structures that would not be the solution format sequence (why 2 interim nodes wouldn't work for a multi-layer perceptron)
   translate the structure into language terms relevant to the input/output or at least the adjacent surrounding structures (a ‘node that enables output equivalence or output neutralization’ as opposed to a ‘node with output −2’)
   include info about ‘why’ so the intent/cause is always connected to the structure
      example: include info about ‘why it cant be some other structure’ so structures of ‘requirement’ are included, as structures of ‘cause’ (requirements being causal)

example of applying interface analysis to derive the structure of a ‘neural network’
derive neural network structure from standard solution like ‘regression’
   how to get to the core structure of neural networks (‘filtered recursive sums of weighted variants of inputs’) from the ‘regression function’ solution-finding method
      standard linear regression has the structures:
         ‘error definition’ (the ‘error-calculating function’, such as a ‘sum of differences in actual/predicted y-values’)
         ‘weighted average’ (the regression line represents the data points fairly, using equal weights, in the error-calculation function, where no actual/predicted y-value difference is weighted higher than another when they are summed)
   to connect these structures to the solution output of ‘neural network’ structures, like the following:
      ‘repeated combinations of weighted input variants’
   we can apply various alternative structures of standard structures like ‘difference’, such as:
      a ‘difference’ in connecting these structures than the connection method that standard linear regression uses to connect them
      a ‘difference’ in ‘weighted averages’ (in the form of a ‘weight difference’ as in non-equal weights, or as in a ‘previous/new weight difference’ to indicate a ‘weight update’ function), applying ‘error reduction as a solution metric/filter’
derive the neural network structure using solution metrics

### Example

deriving a structure fulfilling a solution metric such as a ‘function that can reduce structures of complexity or produce structures having complexity structures like non-linearity’ (which is associated with more complex functions having many change types & involving more variables that would require a neural network)
non-linearity structures: identify structures that are non-linear:
output structures
   curvature: exponents that don't produce standardizing constants can produce a curved line
   disconnected step functions (non-adjacent y-values for adjacent x-values)
input-output structures
   slope changes: a slope change indicates non-linearity
      functions with many variable peaks (like a function that perfectly fits a data set with zero error) are non-linear
   multiple y's for one x
input structures
   multiple input terms that cant be reduced to one term & a constant
      this means ‘multiple constants configuring various possible operations like exponents/multiplication to the inputs’
opposite structures: identify structures opposing non-linearity
   specific regularization or feature-reduction methods are likelier to produce more linearity than other structures
core structures: from these non-linearity structures we can identify ‘constant/variable weights’ (representing the multipliers/exponents), ‘alternatives’, ‘multiples’ (combinations, sets), & ‘high sensitivity to inputs’ as particularly useful structures for building a solution structure
   find how these core structures can be applied in a way that helps ‘reduce structures of complexity’ or ‘produce non-linearity’
      multipliers/exponents have to be non-zero and non-one to introduce complexity or produce non-linearity
      starting from the unit constant of 1, changes must be applied to that unit constant to get to the required constants configuring operations in order to produce non-linearity
         now that we have a requirement (‘change a set of 1 values to a set of non-1 values’), we have a structural version of the problem (‘apply changes to the unit number set to get the correct number set’)
         how can we fulfill this structural version of the problem using the core structures of ‘constant/variable weights’, ‘alternatives’, & ‘multiples’, which we identified as relevant bc they're relevant to non-linearity, which is a feature of complex functions of inputs
         ‘weights’ can be substituted in the ‘apply changes to the unit number set to get the correct number set’ to produce ‘apply changes to the unit weight set to get the correct weight set’ bc ‘weights’ are numbers so they can be injected into the ‘apply changes to the unit number set to get the correct number set’ structure
         Apply ‘inputs’ as a default problem-solving structure, or given its position as the structure that operations are applied to in order to get the output
         ‘Apply changes to the unit weight set applied to inputs to get the correct weight set applied to inputs’
         further transformations can be applied using the core structures:
         Apply ‘multiples’ and ‘alternates’
         ‘Apply changes to alternatives of multiple unit weight sets applied to inputs, until the correct weight sets applied to inputs is reached’
         condense/merge
         ‘Apply changes to alternative unit weights of inputs to reach correct input weights’
         identify important structures
         ‘weighted input variants’ is an important solution structure given this set of transforms, indicating the solution space
         Applying ‘multiple’ again:
         ‘repeatedly weighted input variants’ (to indicate that other layers of nodes/weights may be used)
         given the standard problem-solving intent of ‘filter the solution space’, we know that ‘filters’ need to be applied to this solution space
         ‘prediction accuracy’ of various solution structures (‘weighted input variants’) is the default solution metric
         from this point, other solution structures can be derived as requirements:
         requirement to filter the solution space of ‘weighted input variants’:
         functions to find weighted input variants that minimize a solution metric like “inaccuracy”, to filter weighted input variants or adjust weighted input variants'
         requirement to adjust ‘alternate’ structures of the network, which may contribute to the inaccuracy of a particular solution (‘weighted input variant’)
         functions to remove/adjust variables that don't add solution metrics like “accuracy”’ (where ‘variables’ to be removed/adjusted may be structures of the network, like node units, activation thresholds, propagation functions, combination functions, or weight variants)
         from this, ‘cycle’ structures can be identified as important using another application of ‘multiple’, to allow for more than one update to weights or other structures preventing accuracy of the solution weighted input variant
how to indicate the connection between multiple independent variables & one dependent variable on the same 2d space?
   find a metric that separates the two answers correctly
      if you sum the inputs, you get the same answer for the 1,0 and 0,1 pair set (1), but different values for the other two, and the line generated is a constant
      if you subtract the inputs, you get the same answer for the pairs that should have the same answer
   what is another way to derive the usefulness of linear algebra in this context of mapping a ‘set of inputs’ to an ‘output value’
      many operations & formats can connect the ‘set of x inputs’ and the ‘y value output’
         matrix operations are just one of them
         other operations to produce one value from a set are ‘average’, ‘sum’, ‘type’, ‘compression’
         Among these, the ‘average’ operation combines many values to find a representative value that fairly (with equal weights) represents them all as best as possible
         the adjacent derivation of ‘matrix multiplication’ aligns with this structure:
         matrix multiplication (sum of sets of pair-wise multiplications) can be derived adjacently by applying a scalar to a set of terms, then adding another scalar in another position with the same connection function (sum) as the other terms, then combining them in the same operation as the original scalar
         matrix multiplication multiplies a set of values by a set of values in a one-to-one-mapping
         An average multiplies a set of values by a weight, which may be the same for each value
         both are a sequence of a sum of multiplied terms
         given this structural similarity, the relevance of ‘average’ operations to ‘matrix multiplication’ can be derived
         this gives a function (matrix multiplication) to conduct an ‘average’ or other weighting operations
we need a requirement to match/call the function
   matrix multiplication can also be used to convert a set of values into another—like converting a set of x value inputs into a y value output, as with the weighting function that produced a sum of weighted inputs
   common problem formats include ‘find a prediction function for y given x’, to which adjacent transforms can be applied to generate the multi-variate counterpart, which generates a requirement to call the matrix multiplication function in various positions:
      ‘weighted sum’
      ‘connecting a set of values with another set’
         this can be applied to relevant inputs of the ‘find a prediction function’ problem, like with the input structure of ‘sample data points’ to create a prediction function for
other structures that can be used to derive the concept of ‘neural networks’
   a definition route of a prediction function is a ‘set of constants (like constant exponents or multipliers or operations) applied to variables’, where the unknown (the problem to solve) is ‘which constant values should be applied to the input variable terms’ and how many terms there are
   it can be derived from this definition that a ‘function that filters a structure having many different constants’ is a useful structure to ‘find the right constants to predict the output variable’
      this can be applied as a ‘requirement’ structure of the solution
   benefit/cost analysis
      incentives (to derive functionality of adjusting weights by their cost/benefit)
   input/output similarities (compression, matrix multiplication, decomposition structures, etc have a similar input/output connection variation to the requirement of input/output connection variation)
   requirements/filters
   using standards as a base to apply changes to
   weight/function/activation units representing conditionally non-zero terms in a function to connect example inputs/outputs
   connective/interactive/continuous state sequences (what set of states could be connected & combined to connect inputs/outputs)
   summarizing/representation structures like weighted averages as useful for representing a structure in another way
   consensus structures (where multiple votes are gathered by repetition of positive/negative feedback) as a way to determine importance of a node unit
   alternative structures to allow for a maximally different solution space to be tested
   the emergent structures of a neural network can be derived as adjacent structures (like repetitions/transforms/combinations) of standard structures (like trees/networks/sets)
      neural network structures include ‘repeated combinations of combinations of inputs’ in a ‘tree structure’, in addition to ‘weight paths’, ‘similar weight networks’, & other emergent structures of the algorithm when applied to the network, and when data extremes & other important points are applied
example of how to derive the standard multi-layer perceptron XOR network
   how do you Figure out that (0, 1, 1, 2) is a useful output of the interim layer to combine with a mapping/filtering function that can assign ‘false’, ‘true’, ‘true’, ‘false’ to those outputs, thereby implementing the xor function?
      you can derive increasingly specific requirements of the function as mentioned below, then find a combination of weights/nodes/thresholds that fulfills the most specific requirements you can derive
      you can also derive the structure of the function & their interactions as mentioned below, then find variables that fulfill the structural interactions
   apply requirements: identify increasingly specific requirements & find variables that fulfill those requirements
      this network can be derived by the following ‘requirement’ structures:
         basic input/output requirements
         possible inputs (0,1) and (1,0) must have an output of 1
         possible inputs (0,0) and (1,1) must have an output of 0
      basic function requirements
         the output must be zero for inputs (1,1) and (0,0)
         output of interim nodes allowing sum of 2 from (1,1) must be offset by output of interim nodes allowing sum of (1) from (1,1) (there must be two nodes allowing the sum of 1 from the input (1,1) to offset the −2 from the node allowing sum of (1,1) to output a 1 value (which is then multiplied by the −2))
         output of all interim nodes allowing sum of 0 from (0,0) must always be equal to zero
         the output must be one for inputs (0,1) and (1,0)
         output of interim nodes allowing sum of 1 from (1,0) must be equal to one and there must be only zero outputs of other interim nodes
         output of interim nodes allowing sum of 1 from (0,1) must be equal to one and there must be only zero outputs of other interim nodes
         from the basic input/output requirements, we've derived the requirements for the functions connecting them
         there are other requirements that could connect the inputs/outputs (fulfill input/output requirements), but this is a way that requires minimal nodes
         now we know what the outputs of the interim layer should be
         the other variables include options like:
         how layers are connected (fully connected, or just adjacent nodes, or another way)
         how many nodes are in the interim layer (how many weight combinations of activated nodes produce the outputs) & their weights to produce the correct outputs
         whether other layers can be added to reduce/relocate other operations to add value for another metric
   identify structural interactions & variables that fulfill those interactions
      given that:
         the nodes only interact with two adjacent nodes on the interim layer
         weights are summed in each interim layer node
         inputs have four possible states, of which there are two meanings (true/false)
         sums produce three different values given the two-adjacent node interaction
      what other variable values can combine to produce the input/output mapping:
         what second weight set & interim layer node count combinations could produce the final conversion between sums & true/false outputs, given that the other interactions like sums & two-adjacent node interactions are already defined?
         can the weights applied to the initial input layer (first set of weights) be changed to optimize the other parameters?
         what other adjacent node interaction types (like fully connected layers, as opposed to two-adjacent-node interactions) would combine with weight & interim layer node count & interim layer count variable values to produce the same input/output mapping as the xor function?
example of useful generative questions to apply in an interface query for ‘representing the xor function as a multi-layer perceptron’:
   which variable values would produce input/output connections:
      1 interim layer: which sum of (which weight vector applied to which (weighted input sums))
      2 interim layers: which sum of (which weight vector applied to which weighted input sums of (which weight vector applied to which (weighted input sums)))
   which structures are capable of producing different possible output values (sum, weight application function, weight update function) & which structures are capable of filtering those values (such as an error-calculation function, regularizer/standardizer as a deactivator, input feature-reduction/selection functions)
   to connect inputs/outputs in a sequence, some version of the inputs (produced by applying a change to the inputs) is required to input into the next step in the sequence
      to avoid losing information immediately, a default operation would be to have multiple functions (nodes) in the next step in the sequence, and to forward all inputs to each of the next functions
         if the functions on the next step are similar & to avoid repeating calculations, change the inputs to the next step's functions
         if the functions on the next step are different, change the inputs to the next step's functions to compound change types
      in either case, changing the inputs in some way is advised—how to change the inputs in a useful way:
         apply priority (weight) to different inputs, to test possibilities where inputs differ in priority
         apply sum to weighted inputs to evaluate the weighted inputs with a function that can map one value (sum of weighted inputs) to another value
         these operations assume the sum/weights wont generate similarization in impact on final value of this repetition across node outputs in the same layer
         this is a good example of how structures (input-output sequences to connect problem/solution) can apply to a structure in a way that doesn't invalidate seemingly contradictory structures P4 (input-output networks having loops connecting inputs/outputs applying a solution-finding method to create the solution) applied on another interaction level or to different components of the structure
   what structures applied to inputs (like combinations) would generate probably useful variants of inputs to create the output, & what structures would filter those variants, in a way that the contribution to accuracy of each combination could be calculated?
      what structures fulfill each of these intents?
         intents like: ‘combine inputs’, ‘alternate solutions’, ‘filter solutions’, ‘differentiate/correlate with error’, ‘update alternate solutions’, ‘repeat filter, differentiate, update steps once a solution space is found’
      these intents can be connected with structures like the following to design an initial interface query:
         “‘combine inputs’ to create a solution space of ‘alternate solutions’ then ‘filter solutions’, check if ‘solutions are different from errors or expected values’, and ‘update alternate solutions again as needed”
      this is a general solution automation workflow, with a variation that the filter/differentiate/update steps are a repeated cycle applied to iteratively approach the solution in a state sequence
      from here, generating the neural network structure can be as simple as applying the insight that ‘having ways to deactivate terms in a function (by removing/reducing them) is a way to produce different functions for different inputs’, which is useful when different weights should be applied to different inputs

Example of Other Solution Automation Workflows

What follows are examples of other solution automation workflows.

optimize a useful structure (like a component/function network) for various problem-solving intents on varying abstraction levels (like ‘reduce computation’, ‘retain info’, ‘filter solution space’, ‘solve similar/related problem’)
example: the common system structure of ‘isolated components that are connected by functions to form a network’ can be replaced by other structures using associated useful functions like:
   describe/determine/differentiate: a structure with attributes (or a structure of attributes) that allow interactions of continuous/overlapping components inside the structure or produced by the structure to develop the same input/output sequences as the component/function network to ‘allow variation in components/functions of a network while having similarity in inputs/outputs’
   this can take the form of ‘attribute intersections’, ‘attribute/variable networks’, ‘lack of structure’, ‘overlapping/continuous structures vs. discrete structures’, ‘incentivized but not explicit structure’ or ‘abstract structures’ allowing this similarity to the component function network
   identify/determine/limit: sequences/sets of component/function routes (formatted as pairs, patterns, positions, differences, sequences, interval/degree-based versions of both, non-ordered set versions of both) on the network
   derive/generate/limit: filters/functions that generate the component/function network to ‘find cause of interactions of a network’
      standardize: a simplified/compressed/parameterized form of the component/function network to ‘find a default network to use when beginning solution search’
      change: an adjacent version of the network (like its opposite) that can be converted to the network with minimal transforms to fulfill ‘opposite’ intents (like ‘cause a problem to test robustness’)
      determine/limit: a set of inputs/outputs that can be used to uniquely determine the network to ‘reduce computations’
      a non-unique component/function network, which solves the problem of a unique component/function network enforcing a static state, whereas a network allowing repetition allows variation to be stored in alternate versions of a component/function or other structure to ‘retain info about network uses & different component versions’
         an alternative would be a case where uniqueness & abstraction are enforced, where if a particular component/function needs to be changed, its parameterized to support that intent rather than creating a duplicate version that can store the changes
         unique networks also lose info of usage routes & the associated inputs/outputs of each route in addition to losing variation in this way
   this workflow involves a useful type of function that is ‘adjacent’ to problem-solving intents (‘reduce computation required’ is adjacent to the problem-solving intent ‘solve problem in the most efficient way’ and applies a ‘core interaction function’ like ‘reduce’ to a ‘solution metric’ like ‘computation required’) but is not specifically connected to problem/solution structures

Abstract Interface Queries to Generate Workflows

### Example

workflow: apply the function generated by the interface query ‘apply format sequence to connect the “categorize” problem input with a solution format’ as a general solution function for ‘categorize’ intents
   identify known relevant info
      identify known types
         identify functionality of known info
         known types are a ‘final filter’ to apply before the solution format is reached
         identify relevant interface structures
         identify variables (isolatable change types)
         identify functionality of relevant interface structures
         variables can be applied to find similarity to other variable values & to average type values or value ranges
         variables can be applied to change variable values
         identify possible interaction between functionality of known info structures & relevant interface structures
         Applying changes to an input (data point) can identify ‘degree of difference’ between the input and a type value range or average type value, which can be used as the ‘final filter’
         identify if possible interactions are useful for a given intent
         Applying changes to identify ‘degree of difference’ is useful for the ‘final filter’ intent (‘categorize’ intent)
      the interface query is generally to ‘identify missing info & functions to find/derive/generate that info’, but specifically implements it as:
         abstracted workflow:
         ‘identify info & interfaces structures and their functionality, and the interaction of that functionality, and the useful interactions among those functionality interactions for solving the specific problem’
         this can be generalized into another solution automation workflow
         ‘identify structures & their structures & the interactions of these structures, filtering for usefulness for problem-solving intents’
      the ‘solution function’ output by this query is ‘apply changes & identify if the differences required to convert a data point into a clear member of a type are greater for one category than another’
      the workflow to generate a solution function for ‘categorize’ intents involves generalizing that interface-query generated solution function for varying ‘categorize’ problems & applying that as a solution-generating/finding function for ‘cateogorize’ intents
      the general workflow is to generalize the design of interface queries (to identify missing info & functions to find/derive/generate that info) to fulfill specific problem-solving intents, rather than solving a specific problem
         ‘functionality’ is a specifically useful & important structure, so the specific interface query can be retained, or it can be fully generalized & the ‘useful structures’ can be a variable rather than specifying ‘functionality’ as a useful structure

generate workflows based on other core interaction functions than ‘connect’ & ‘interact’ & ‘filter’ since many are based on those functions
connect: ‘connect problem/solution structures’, ‘solve adjacently related/connected problem’
reduce: rather than workflows to ‘connect a problem/solution’, workflows to ‘reduce a problem into a solution’ or ‘reduce a problem into a non-problem or neutral structure’
abstract: ‘abstract/specify a solution & solve for the abstract/specific/example solution instead’
filter: ‘filter the problem attributes to just the relevant attributes’ and ‘filter the problem attributes that cannot be converted into solution attributes’
interact: ‘determine which interface queries interact in a way that allows the problem/solution to interact in a way that fulfills a core interaction function’, ‘determine which function interaction levels, workflows, queries are interactive’
multiple: ‘determine which interface objects interact in a way that fulfills multiple core interaction functions’ (given the insight that functions which generalize tend to be more useful & accurate)
missing: ‘determining which functions are missing & could be generated that would solve the problem more quickly than existing functions’
position: ‘position the problem so its a neutralizing structure (a problem for a problem), or a non-problem, or not interacted with’

identify interim & cross-interaction level functions & other interface structures that fulfill various workflow variations (like fulfilling a specific core interaction function)
connect: ‘find structures fulfilling an interaction or connection structure, like a sequence/tree/network’
reduce: ‘find the important variables’ is a function that is particularly useful for the ‘reduce a problem’ problem-solving intent
abstract: ‘find abstraction levels that tend to be useful for resolving a particular uncertainty type’, ‘find’
filter: ‘find the most reductive filters that don't lose an info type’
interact: ‘find interaction structures of interaction structure (gaps, overlaps, intersections)’
multiple: ‘find solutions fulfilling multiple metrics’
missing: ‘find gaps in functionality that would be useful to fill’
position: ‘find position of a structure where functionality would develop’

find solution format merge/conversion functions as a way of finding new solution output targets that fulfill solution metrics (like the solution is more adjacent or fulfills more problem-solving intents or solves more problems or is more robust to changes)
example of different input/output pairs applied as problem/solution states
   a ‘find a prediction function’ problem can be formatted as the problem of ‘converting points into a continuous connection structure’ or ‘converting an x value into a y value’, which would have different associated solution formats (such as a ‘regression or regression-function-finding function’ or a ‘function to find the other variable value in a point set (x,y) based on some representation metric like an average of a set of adjacent example points’)
      the inputs/outputs are different across these formats
         one starts at a set of points that can be used to test the function once found, the other starts at a specific input value x of the function
         one ends at a function, the other ends at a y-value
      the function that could merge these solution formats or convert one into another would be useful in cases where one solution format is more adjacent than another
         this can also be useful to solve for components or steps in a problem-solving workflow that can be more adjacently solved in another format

map solution automation workflows to a specific problem format (‘find a prediction function’, ‘solve system of linear equations’) and/or solution format (‘regression’, ‘neural network’, ‘matrix multiplication’) that supports a high variation in interface structures (like ‘change types’) and apply useful functions to structures in that problem space to identify missing workflows in that problem space that could fulfill a problem-solving intent connecting those structures, or map the problem format to an alternate solution format more adjacently (like how a particular function of inputs may be guaranteed to generate enough difference to represents points in another dimension as needed, while operating in the original dimension set)
in order to fulfill an intent like ‘compress’ of the input x values to the output y value, the neural network does a seemingly counterintuitive/opposing ‘expansion’ operation, generating a ‘combination space’ of weights & input sets, which generates a ‘possible solution space’ of ‘weight variant structures’, to which it applies filters in the form of ‘activations’
   in this sense, the neural network is fulfilling a standard general solution automation workflow of the sequence of interactive problem-solving intents:
      ‘generate possible solutions & then filter’
   this workflow involves mapping other solution automation workflows to the ‘find a prediction function’ problem format or the ‘neural network’ solution format, where some solutions are known, and where connections between structures can be measured directly, allowing some structures to be identified as interactive/different, which makes them a possible solution for workflows connecting/differentiating/interacting between various problem/solution structures, like by implementing a useful function like ‘organize’ or ‘standardize’, or problem-solving intent like ‘find a solution-finding method’
   when formatted with a different solution format (like matrix multiplication), the problem becomes ‘find matrix multiplication operations that would speed up the connection between inputs/outputs’ or ‘find the matrix multiplication operations that would map inputs/outputs while allowing a sequence of ‘combination’ & ‘alternative’ & ‘filter’ structures in between inputs/outputs' (matrix multiplication operations that involve expansion into alternate matrix multiplication sequences followed by compression), so that different inputs with different optimal multiplication sequences can be retained if there are multiple optimal sequences
   applying a different solution format has value in solving a particular problem in general, and may have additional value when mixed with different problem formats (‘find a prediction function’ may be more adjacently fulfilled with matrix operation derivations to connect inputs/outputs by generating & connecting combinations/alternatives/filters/compressors than training a neural network)
   these useful solution formats (which any solution can be formatted as) are interactive with solution automation workflows, implying an ‘interchangeability’ that is often associated with an ‘interaction level’, indicating the useful solution formats represent a core structure like a ‘difference/tension resolution method’ that aligns with the ‘difference resolution’ intent of the problem-solving intent of ‘connecting problem/solution structures’, similar to how other structures like problem/solution structures are interactive & may be interchangeable in some circumstances (given that one implies or even specifies the other, can be used to derive the other)
   these useful solution formats also offer powerful solution metrics like ‘efficient stable flexibility’ (consistent across best/worst cases), which is a structure that would describe other solution formats than neural networks, like matrix multiplication, as well as the variety of error calculating methods & metrics inherent to regression, so they can be used as solution-finding structures (like ‘find a prediction function for any variable set’) as well as solutions to specific problems like ‘predict y from x’
   generalization: structures that can handle more change types are more adjacent to the concept of a primary interface where any problem can be solved, so this can be generalized to ‘find/derive/generate structures that can handle the maximum change types’ as a way of finding alternate systems that a problem structure can be formatted to that makes solving it more adjacent

apply useful structures like similarities to find other useful structures like proxy/interchangeable structures (like ‘finding solution cause-generating function’ or ‘finding a solution-finding function’ rather than ‘find a solution to “predict y from x”’) that are more adjacent to fulfill a problem-solving intent or solution automation workflow for
this workflow fulfills the problem-solving intent of ‘changing the solution target’
workflow fit:
   this workflow applies a workflow (‘apply related structures to find/derive/generate each other, like similarities/proxy structures’) to fulfill a specific problem-solving intent ‘change solution target’ in a way that can find/derive/generate other problem-solving intents (‘find solution cause-generating function’)

find which structures (in a specific interface) can fulfill a useful structure (like ‘derive’ function) of another structure (in a specific interface), as a method of finding/building/deriving/applying alternate structures to find/derive/build/apply that useful structure (which may be specified in another or a standard solution automation workflow)
example: a structure (like a combination or sequence) of ‘input/output requirements’, ‘core functions’ or ‘differences between functions’, ‘function sequences’, ‘interactive structures’ or ‘matching outputs-inputs’ can be used to ‘find’, ‘derive’ or ‘build’ an ‘input-output sequence’ or ‘connection sequence’, be these structures are particularly useful for finding/building/deriving input-output sequences
their relevance is be they are either directly connected to the inputs/outputs required or they can adjacently create direct inputs of other required structures
how to derive structures that would be useful to fulfill ‘problem-solving intents’ or other ‘useful functions’ (like find/derive/build/apply) of useful structures
   assume the input/output sequence is the ‘target solution output’ and:
      assume other structures with inputs/outputs like ‘functions’ are relevant to building this particular input/output sequence (to derive ‘functions’ as a useful structure)
         given that functions are useful structures:
         identify a function-reducing structure like ‘function differences’ to fulfill the ‘find’ intent of relevant functions
         fulfill the ‘build’ intent of that output (to derive ‘core functions’ as a useful structure)
         identify structures (like sequences) of functions that could be useful to connect inputs/outputs (to derive ‘function sequences’ as useful)
         assume other structures having an overlap/alignment in intents (like ‘connect’ or ‘equal’) with the intents of the input ‘sequence’ structure would be useful (to derive connectible structures like ‘interactive structures’ or ‘matching outputs-inputs’ as useful)
         assume structures that must be available (like ‘requirements’) can be used as assumed inputs as well as filters of other structures (to derive ‘requirements’ as useful)
      these all apply a ‘structural similarity’ (between inputs/outputs and functions, or between ‘connect/equal’ and ‘sequence’) or other default/known useful structure like ‘requirements’ to find/derive/build other useful structures that can be used to find/derive/build/apply or substitute for a particular structure like input/output sequence
   workflow fit: this is related to workflows involving useful structures but involves applying useful structures to fulfill find/derive/generate intents of useful structures to find alternative useful structures

format problem structures in various default formats determined by various useful structures (like core interaction functions such as ‘filter’ or interfaces like ‘change’), where the useful structures have associated useful structures to design structures of these useful structures that can be used to fulfill problem-solving intents
like how by default:
   ‘strictness’ is relevant to ‘filter’ intents
   ‘change types’ and ‘change units’ and default operations like ‘combine’ are relevant to ‘change’
change
   identify relevant unit structures (‘change’ unit structures)
   generate structures of ‘completeness’ of relevant unit structures (‘all possible combinations’ of change unit structures that can be used to create other changes)
   find contribution of each change structure, prioritizing solution metric of ‘fewest possible change structures’
   solve for changes (v,w,x,y) applied to all possible types of relevant unit structures (change unit structures, like variable, variable transformation, & variable interaction units) to generate output z
      v*core change unit+w*synced change unit+x*compounding change unit+y*constant change unit=z
filter
   strictness: apply filters of varying strictness as needed
      required
         probable
         possible
these structures have associated useful structures by default be of their definitions, and they can be used to represent/solve all problems/solutions
workflow fit: this is related to workflows involving useful structures but involves deriving default useful structures associated with another useful structure & applying that default useful structure to format a problem in a useful structure where its more solvable

apply useful structures to fulfill problem-solving intents applied to problem/solution structures, to find new solution automation workflows
example: apply ‘input-output sequence’ to fulfill problem-solving intent of ‘filter solution space’ or core interaction function ‘connect’ applied to problem/solution structures to identify new ways problem/solution structures can interact in a useful way (as in fulfilling a ‘problem-solving intent’ like ‘find new solutions given known solutions’ or ‘filter solution space’)

derive error metrics (indicating an incorrect solution) that could have solved the problem faster if known in advance & apply to fulfill problem-solving intents like ‘filter solution space’
example: for the ‘find a prediction function’ problem, find neutralizing differences as a way of finding a ‘balanced/representative/average’ or ‘approximate/general’ solution that minimizes some error
   derive input/output-connecting metrics of successful prediction functions
      input/output-connecting metrics could include:
         the ratio of numbers of data points above/below or difference between local/absolute extremes or near/far or points on exponential/constant/subset connecting lines from a successful prediction function representing those points
      nn algorithms are not really ‘learning’ in the sense of learning ‘absolutely new info’ (only locally new info about which way to move weights) so much as ‘approaching an equilibrium representing a data set’
      the equivalence represented by the function is the balance between differences like errors & sample statistics, incentivizing the decrease/increase of a particular output value for the function, which is represented in a standard implementation using an average to represent/approximate that equivalence
      other structures that represent a ‘balance between differences’ can also act like a symmetry/equilibrium, and other representation structures can be applied to find alternate/subset/integrated prediction functions
      once the prediction function is known, derive a custom ‘error metric’ (similar to least squares) that could have been applied to arrive at the output prediction function faster, and derive an algorithm that could have connected inputs/outputs to the error metric, so the logical flow is ‘predict useful error metric for these inputs/outputs’ then ‘apply error metric to find prediction function’
alternate ‘representation’ structures would include:
   high-priority points, where x-values that map to an less important y-value are instead assigned the adjacent high-priority y-value
   another algorithm to select a more representative adjacent point or to select between equally adjacent & high-priority points
   find & apply ‘adjacent averages’ if the data set is adjusted in some way like with regularization or imputing missing values or applying an adjacent transform or identifying alternate population means with random subset sampling
generalization: this is different from other solution automation workflows in that it connects problem inputs (data points) and solution outputs (prediction/summary/representation function) using relevant statistical metrics like averages about the input/output connection function that can be used to find the solution output faster be the statistics are relevant & descriptive of the solution requirements & the problem/solution connection (the ‘average’ is relevant to intents like prediction/generalization/representation), and it applies similar inputs (like error metrics) to related solutions like regression to optimize finding the prediction function, so the problem becomes a problem of solving a related problem (regression) with a known solution or solution-finding method

apply useful structures to fulfill useful core interaction functions (like ‘replace’) applied to other useful structures with known solutions to fulfill problem-solving intents like ‘find new solutions’
example: with the ‘find a prediction function’ problem that applies insights about optimal interaction rules (like ‘regularize’ to ‘generalize’) and structures (like ‘alternate routes to support non-linearity’), other structures that can replace an ‘alternate route set’ or ‘input-output sequence set’ include:
   other structures that a neural network can support to capture useful structures like ‘change types’, in addition to or replacing ‘alternate routes’ (which can be implemented specifically as ‘input-output sequences’)
      ‘Alternate definitions (definition of difference, relevance/significance, representation/average, cost) & functions (routing, activation) & constants (initial weights, learning rates)’
      ‘Alternate structures (trees, networks, routes)’
      ‘Alternate data sets within a change range’
      ‘Alternate start/end points’ (start with different variables, aim for different output variable that has relevance to the original problem)

filter structures of truth by those structures which don't require a structure of falsehood to fulfill core interaction functions like ‘connect’
example: for the ‘find a prediction function’ problem, filter out variable interactions that can only be connected using structures of falsehood (lie of omission, false equivalence, etc)

identify the meaning (context, or ‘system fit’) of existing solutions, & apply methods to abstract the meaning to generalize it to other contexts, switch contexts & execute other meaning operations that are useful for fulfilling problem-solving intents
example: for the ‘find a prediction function’ problem, the meaning of a particular regression function would include various definition routes, such as:
   ‘the regression function, given the data set, pre-processing (data conversions, data filters, data standardizations/normalizations, etc), error function, & method to find the regression function’
   ‘the application of the concept of average to find a line minimizing error determined by a particular distance definition from that average, given data preprocessing, error function & regression function-finding method’

derive meaning of a problem & its associated solution meaning to detect if a context switch or meaning generalization can be a useful structure for a problem-solving intent
example meanings of a ‘problem’ include:
   ‘A difference that shouldn't exist, given rules about what differences should exist & the definition of a difference’
   ‘A structure that shouldn't exist, given rules about what structures should exist & the definition of a structure’
   ‘A change that shouldn't occur, given rules about what should change & the definition of a change’
example meanings of the associated solutions include:
   ‘A function to reduce differences that shouldn't exist, given rules about what differences should exist & the definition of a difference’
   ‘A function to remove structures that shouldn't exist, given rules about what structures should exist & the definition of a structure’
   ‘A function to prevent changes that shouldn't occur, given rules about what should change & the definition of a change’
   ‘A generative function of solutions to this specific problem type’
   ‘A solution-finding function of solutions to this specific problem’
   ‘parameters of generative functions of solutions that would solve this specific problem’
   ‘A function to change parameters of generative functions of solutions to solve problems in general’

identify more accessible info structures that can act like structures of truth even if theyre not & apply as structures of truth conditionally where possible

### Example

for the ‘find a prediction function’ problem, a ‘sample data set+regression function’ or a ‘sample data set+regularization+neural network to find prediction function’ are not explicitly structures of truth (the data may be inaccurate or contain noise, the neural network may not produce an accurate answer, the regularization may remove conditionally important info) but it has enough structures of truth (such as insights like ‘remove inputs that don't change the output’ and ‘don't create a function that fits data samples perfectly to allow for generalization’) applied that it may act as a good approximator/predictor of truth in some contexts (such as if the data has a sufficient ratio of correct points, if the neural network has enough nodes/layers to capture the complexity of the variable interactions, etc)
   similarly, structures like ‘consensus from democratic or weighted voting’, ‘patterns’, ‘useful structures’, ‘implications’, ‘difference from average’, ‘probability’, ‘previous success’, ‘prior information’, and ‘correlation’ may act like structures of truth even when they're not, so these structures (& other useful structures) may act like a temporary substitute for truth when it isn't available (when ‘no structure like a combination of known truth structures aligns/fits’)

apply useful structures like ‘alternative routes’ to important/useful structures in a problem space (like ‘probability of solution success’ of an approximated or neural network-derived prediction function or composition/ensemble of multiple alternate functions or function subsets) in the form of solution metrics (like ‘accuracy’)
for example, for the ‘find a prediction function’ problem, apply ‘alternate routes’ to ‘probability’ to find other solutions to find useful structures like ‘probability of solution success’ among relatively similar possible solutions, using aggregation/integration structures like ‘averages’ or selection structures like ‘filters’ to ‘filter the solution space’, by applying ‘alternate routes’ and ‘averages’ to useful relevant structures like ‘probability distributions’
   calculate different probability distributions for each point in a set of ‘important points’ (like points on an input interval in the data set) with a big enough interval to connect the points in a generalized function, such as:
   probabilities determined by adjacent points & adjacent point sequence/set patterns (patterns scoped generally, or for this data set, or for similar input variable change types, etc)
   probabilities determined by stat measures like averages/modes & variance
   probabilities determined by function/variable interaction patterns
   use a weighting/prioritizing scheme to weight these distributions to predict a point given surrounding points, input variables, variable interaction patterns or other function structures
   remaining points can be filled in if the interval is small enough to avoid missing important unique difference types or repeated difference types between other intervals
probability is an inherently important concept to ‘prediction functions’, and the probability of an output is an inherent statistic to functions in general, so its important that way, but is also important in that it can be used to differentiate solutions & measure their success & anything else that probability can be applied to help predict, given the complexity of differentiating between alternate prediction functions in some cases, like between those produced by slightly different neural network configurations or data sets
where probability distributions are those of related functions & subsets of the data set, such as where probabilities are determined as the conditional probability, given the implication of the slope change patterns of a subset of one possible likely prediction function, so this involves forming prediction functions for a point based on other points
   apply prediction functions of structures (like points) given other structures (like subsets or adjacent points) to find a prediction function of the whole data set

avoid over-simplifying a solution so it appears to have no errors (or not identifying errors in a system where errors would be expected) by applying error structures (where they are likely to be erroneously missing) to build a more robust solution that handles errors

### Example

for the ‘find a prediction function’ problem, some variables cant be used to predict some other variables, so in a prediction function of those variables, errors would be expected (‘no errors’ would be the error in that function)
   structures like ‘similarities’ or ‘differences’ are useful for a few different intents like ‘compare’ or ‘identify’ or ‘filter’, so if the problem requires more functionality than these functions can adjacently compose, there is a missing structure to avoid an over-reduction error
   over-reduction error can occur by reducing a system to just similarities/differences, without the connecting functions on other interaction layers building meaning out of those similarities/differences (such as why are they different, in what contexts are they different, what types of difference are included in that difference, and how is that difference useful to other structures)
   even if a problem can be solved in some case (like a best case) by over-reduced structures, its unlikely to be a robust solution that can change as needed according to input changes
generalization: this can be generalized to finding ‘errors in errors’ (a ‘lack of errors’ in an open system where variance would be expected is an error (a ‘lack’) of an error)

apply relevant functions (like a ‘reversal’) that preserve functionality in a useful way to structures with relevance matching structures (structures that have a ‘sequence’ like a function) to identifying alternate routes
example: the function ‘understanding a system is a way of generating it’ can be reversed to ‘generating a system is an input to understanding it’ if ‘understanding’ is the target output

identify optimal states (destinations) and work backwards to identify error states (origins) that an agent with a valid intent in the system might occupy that could be considered problem states, which are separate from the optimal states, optionally with error structures like barriers/gaps separating them, and identify routes & route patterns to connect those problem/optimal states of a problem space, as well as standardizing transforms of the problem space & corresponding state points that would reduce the problem into a more obvious solution set of connecting routes, to apply these routes & route patterns to other standardized problem spaces

apply ‘approximate’ structures of ‘useful structures’ like ‘input-output sequences’ (such as ‘sequences with approximate input-output matching’) as a way of finding useful structures to fulfill problem-solving intents
generalization: apply other problem-solving intent (like ‘filter solution space’) & related function type functions (like standardize, organize, approximate) to problem/solution structures such as useful structures as a way of finding adjacent & other important structures of problem/solution structures

standardize problem to a standard format & apply standard solutions for that format

### Example

if problem input data has a sequence or a correlation or a variable (change type) structure, it can be identified by variable solutions like specialized machine-learning algorithms/networks
   standardizing to ‘change types’ could invalidate the gains from specialized networks/algorithms
   changes in a ‘sequence’ can be formatted as ‘adjacent change sets’ to represent changes usually found together
   ‘correlated’ changes can be formatted as ‘aligned change sets’ to represent changes that co-occur

identify perspective that minimizes errors according to the solution requirements & apply that perspective as a solution filter
example: for the ‘find a prediction function’ problem, the perspective of ‘find the average function’ (a perspective which prioritizes common general expected values & patterns rather than specific examples & therefore has the implied errors associated with that priority) has errors of ‘possible high differences between actual & average value’, with an opposing error of the opposite solution ‘find the best-fitting function that accurately predicts every point’ being ‘possible high differences between one sample value and another sample value’, and if the solution metric is ‘accuracy’, error types of a solution that maximizes ‘accuracy’ would be preferred over error types of other solutions

incentivize or otherwise maximize errors to create the most differences between error & solution possible, then apply opposite structures to errors which should create solutions once theyre maximally different
workflow fit: this is a corollary to the ‘apply differences to errors to create solutions’ workflow, but errors may be closer to their maximized state than to solutions, in which case this workflow would be more optimal

create a space where points represent states of variables that differentiate solutions & other states, where known solutions are indicated by minima or maxima, then identify useful structures like ‘patterns of point sampling to find maxima quickly’ and ‘differences between solutions & other states’ and ‘differences in useful structures for solution-finding across different state spaces’ and ‘maximum change types between adjacent or any points (like exponential, signed change, intersection/zero/tangent-crossing change, etc)’
a variant of this would be an ‘error state space’ where known conceptual errors like ‘inaccuracy’ and ‘over-simplicity’ and ‘trade-offs’ occupy maxima and minima are found as possible solution states
a space can have overlaps in the structures determining errors, so isolating interface structures would be ideal, so that an error of ‘ambiguous cause’ would occupy a different point than an error of ‘false similarities’, but these would overlap semantically, as a ‘false similarity’ can indicate an ‘ambiguity’, so the state variables would have to be isolated as much as possible rather than including semantic overlaps, or overlaps could be indicated by other structures and the number of error structure overlaps closest to zero would indicate a possible solution structure, where structures would be arranged so that their semantic positions would be as adjacent as possible to form the corrollary of ‘areas’ (rather than a ‘false similarity’ appearing in multiple very different points)

standardize solutions from other systems & convert them to the problem system, calculating any missing solution structures & determining variables & generative functions of solutions & useful structures like efficient routes to solutions from input problem starting points
example: for the problem of ‘finding a sorting algorithm’ (like binary trees), standardize solutions so they can be applied to ‘find a prediction function problems’ (like bi-directional function non-linearity additions or other changes)

solve a more complex problem first & apply as a solution space or solution-finding method filter to find simpler problem's solutions in that problem space quickly
example: for the ‘find a prediction function’ problem, solve more complex prediction problems like ‘whether a solution is biased’, ‘the correlation between AI research & weather’ (should be somewhat correlated bc extreme weather requires tech to survive) or ‘the correlation of interaction patterns of an environmental system with a social interaction pattern in cities’ (should be correlated bc of system similarities in complexity, structure, & other attributes) and apply as a filter to simpler problems like ‘find the correlation between these adjacent variables in the same system’ (which are likely to have causal relationships so their interaction should be determinable with simple statistical methods rather than requiring complex analysis), which should have simpler relationships than the corresponding complex problem, and any simple prediction problem within the same system should necessarily have less variation structures than the complex prediction function of a system it inhabits, so the complex solution should be composable with the simple solution, and other logical relationships between these solutions should also hold

apply solution improvement/optimization patterns to generate solutions & derive more efficient methods of applying these improvements
example: for the ‘find a prediction function’ problem, this could take the form of applying adjacent operations like shifts & adding exponents to specify the function for the data set, & stopping specification at a certain point to avoid over-specificity, and a more efficient method of generating these improvements could be ‘deriving average difference or difference patterns from function & data points & generating functions having that average difference or difference patterns’
the ‘more efficient method’ finds a ‘vertex variable’ in the form of the ‘difference structure’ applied as a ‘requirement’ of the solution function, which can generally ‘find & apply useful structures to fulfill problem-solving intents’ or specifically ‘find a reduced route between input variable values & the prediction function’

find interface structures like ‘interaction levels’ where changes can align, as a component of solutions where change input/output is known on one level but not another & the interaction on another level is the target solution, or where the problem can be solved on the other interaction level

### Example

levels of interaction where changes align in the machine learning (specifically the multi-layer perceptron example) structure include:
   weights/thresholds/biases & sum/routing/activation functions
   value changes from inputs to outputs
so the unknown changes can be in one set of parameters that enable another set of known parameters
   unknown parameters (weights/thresholds) and known parameters (sum/routing/activation functions)
   unknown parameters (weights/thresholds & sum/routing functions) and known parameters (activation functions & required value changes (labeled data))
another example would be where the high-level or general intent requirement is known, but the sub-intents to fulfill that high-level or general intent are not known, on another more specific interaction level

if existing problem/solution structures (like useful functions) don't solve a problem, derive errors in those structures (like missing functions) & solve the problem of correcting those errors

### Example

for the ‘find a prediction function’ problem, if a causal relationship cant be established using time-based structures like chronological sequences, check if other structures can be explanatory, like adjacence determined by similarity (of inputs or position or interaction level), which is a good approximator of cause when sequential causal structures like causal chains cant be verified
   if no structures are sufficient to explain a variable relationship function, then there is an error in the structure set, such as a ‘missing structure’, which may be found by applying interaction functions to structures (like function types) that haven't been connected yet

find the interface structures like interaction level of related/sub-problems & sequence of sub-problems (related/sub-problems of the original problem, which are solved in the interface query) where connections can most efficiently & otherwise optimally be made (using adjacent or available operations) and solve the problem there first, then design the rest of the interface query to fulfill that solution on other interface structures (like on other interaction levels)
example: find out if solving the ‘input-output connection problem’ as a sub-problem of the ‘find a prediction function’ problem using a function & weight network can be solved more efficiently by connecting value sequences first, or by connecting function input-output sequences first, or by deriving weights first & then other parameters like threshold values, or the reverse, etc

connect adjacent structures to find standard/base solutions (like ‘where adjacent point-connecting functions create averages that intersect to create a regression function bc an average is by definition related to the prediction & is also relevant as a symmetry structure’), and connect aligning structures on multiple interfaces to find meaningful solutions (like ‘where subset functions are reflected in an aligning neural network structure, thereby also creating an alignment between inputs/outputs to model more nuanced change types, bc the network can support customized function units representing local average functions, allowing the solution to be re-used across many function types’, which aligns on the structural interface bc of the ‘structural similarity’ between subset function & the local averages formed in neural networks, and the system interface bc of the ‘alignment’ structures and the meaning interface bc its ‘useful’ for other queries) bc some structures like adjacence/alignment can more optimally find solutions of a particular solution metric like accuracy

find useful interactive structures (like ‘matching structures’, such as ‘requirements’ & ‘functionality to fulfill requirements’) as an input to problem-solving intent functions, workflows, or interface queries

find symmetries & variables/functions of them between alternative workflows having the same problem/solution structures & result, and apply these variables to generate other workflows
example: ‘aim for adjacent state to the solution instead of the solution, then transform it to the original problem solution’ and ‘solve a different but similar problem’ and ‘solve the opposite problem, then transform it to the original problem solution using opposite structures’ can both have the same resulting interface query & result
their common structures involve variations of the ‘aim for a different problem-solving intent or destination’ and ‘change a base solution into the original problem solution’ functions, to which changes can be applied to generate other workflows
examples of ‘adjacent states’ or ‘similar function formats’ for the ‘find a prediction function’ problem include ‘parameterizing a function based on a general function specified by the parameters’ (where the function would be in the format of the ‘parameter values’)

apply useful functions/structures to describe a problem space's interactions so that if structures of those useful structures don't solve the problem, any other interactions must necessarily contain the problem structures
example: identify all the structures in a problem space that would be the output of the ‘find’ function (identify all the ‘definitions’ that would be found by applying the ‘find definitions’ function to the problem space)
then do the same for the other useful functions (‘organize’, ‘explain’, ‘reduce’, ‘connect’)
once you have the problem space described by these functions/structures, if the problem isn't solvable using those structures, then the other interactions not mapped by those useful functions/structures must contain the problem
this applies the ‘opposite’ structure to create a ‘solution space filter’, where possible solutions are initially the set of structures of useful structures and if not found among those structures, the solution space is the set of structures not mapped by the useful structures
this mapping can be re-used for future interface queries in that problem space

apply interface structures to the cross-interface interface structure (apply ‘differences’ to ‘variables’ which are both on a cross-interface structure connecting associated structures on the structure/change interfaces), given that the cross-interface structure forms a symmetry of related structures and applying changes to this symmetry would identify alternate combinations of structures that preserve the original meaningful connection, as a way of generating useful structures

identify ‘problem-function connecting’ functions on the interaction level of specific problem structures and other function types, such as ‘overlap equivalent problem structures’ or ‘limit possible connections between problem structures’ as specific useful structures in the problem space to start from, to fulfill the ‘filter the solution space’ problem-solving intent
this connects other function types with problem structures, other than general known problem-solving intents like ‘filter the solution space’ or ‘reduce/remove the problem or its cause’ and generally useful function types like useful interface functions like ‘find structures in a structure’, and core interaction functions like ‘reduce’ and general functions like ‘find’ or interim functions like ‘organize’
useful structures produce some output that fulfills a useful intent, and functions that connect problem/solution structures with other useful structures like useful functions, either generally or specifically, would also be useful by default
generalization: a generalization of this workflow would be to find a function interaction structure (like an interaction level or interaction level cross-section) that would be particular useful for solving a problem, and find/derive/generate functions on that interaction structure
example of creating a logical ‘requirement’ structure by applying interface structures (like ‘equivalence’, ‘definitions’, ‘connections’, ‘interim structures’, ‘overlaps’, ‘skips’, ‘new structures’, and ‘difference/opposites/reversals’)
‘requirement’ rule structure created by two initial rules:
   ‘if all cats are mammals, and a particular animal is a cat, then that particular animal is required to be a mammal by definition’
why is this true? bc:
   one of the objects has a definition:
      a ‘cat’ is ‘defined’ to be a ‘mammal’
   and another object has a definition:
      a ‘particular animal’ is ‘defined’ to be a ‘cat’
   using the connection function ‘is’, indicating some form of ‘equivalence’ or ‘containment’
      the connection function ‘is’ indicates equivalence (a cat=a mammal) in this context
         theyre equal in the context of ‘containment/possession’, not in the context of ‘identity’
         ‘is’ here means ‘is a member of the type’: ‘a cat is a member of the type of mammal’ and ‘a particular animal is a member of the type of cat’
   and a ‘connection’ in the form of an ‘equivalence’ exists between these two defined ‘equivalence’ rules
      a ‘cat’ is in both of the rules, indicating an equivalent structure they have in common, thus forming a basis for connecting the rules around their common component
   and an ‘equivalence’ in the form of the equal connection functions
      the connection functions used in both rules are also equivalent (‘is’ is used in both rules)
   alternatively, there is an ‘overlap’ structure between a ‘particular animal’ & a ‘cat’, and between a ‘cat’ and a ‘mammal’, which create another overlap structure between a ‘particular animal’ and a ‘mammal’
      which means that:
         a ‘requirement’ in the form of a ‘combination’ rule or ‘overlapping rule sequence’ can be created
         the rule “a ‘particular animal’ is a ‘cat’ is a ‘mammal’”
      a ‘requirement’ in the form of a ‘new connection’ or a ‘interim node-skipping rule’ rule can be created from the equivalences in the connection function ‘is’
         the rule “a ‘particular animal’ is a ‘mammal’”
         the ‘interim’ structure of a ‘cat’ can be removed, since the ‘is’ equivalences connect the objects, and applying the corresponding version of the attribute of ‘associativity’ available to equivalent operations
      a ‘requirement’ in the form of a ‘connection rule limit’, in that the following rules cannot be applied to ‘connect the defined structures’, only to ‘limit possible connections’
         attributes that reverse the order of the connections cannot be applied in an equivalent way
         the reversed-order rules of ‘a mammal is a cat’ and ‘a cat is a particular animal’ cannot be applied to infer the rule that ‘a mammal is a particular animal’ (false because it implies that ‘all other mammals that are not the particular animal are not mammals’)
         the reversed-order context-specific rules of ‘a mammal is a type of cat’ and ‘a cat is a type of particular animal’ are similarly false
   in summary, these structures can be applied to generate a ‘requirement’ structure, given how ‘equivalence’ structures can be ‘connected’ and the attributes associated with ‘equivalence’ that can be applied to them
      the primary requirement structure (the associated connection rule) can be inferred in multiple ways, from the multiple equivalences that exist in the initial two rules given
         it can also be inferred by the common component of the two rules, assuming that if two rules have a component in common (‘cat’), they might be related and might interact
         if they further have other equivalences (‘is’) they are likelier to be related
         if their connections indicate equivalence itself (‘is’ is a form of ‘equivalence’) or are a definition route of equivalence or some version of equivalence, they can inherit attributes of the ‘equivalence’ concept definition (like associativity), and their interactions can be inferred from uncontradicted implications or requirements from those related definitions
         the second requirement structure (the limit) can be inferred using opposite structures, to check if the attributes/connections are true once negated/reversed
         this is applied to the attribute ‘order’ of the ‘connection rule’, rather than negating the ‘connection rule’ itself
         so by deriving the concepts like ‘equivalence’ related to a structure (like the initial set of two rules), and pulling the attributes/functions of those concepts given their definitions & applying those to the structures, other structures related to ‘definitions’ like ‘requirements’, ‘limits’, & ‘rules’ can be identified
identifying core/interface structure (like ‘combination’) functions like ‘limit possible connections between rules/components’ and ‘connect definitions by equivalences’ is useful, but identifying how these can add value in this particular problem or how they can interact given their requirements/definitions & other structures is even more useful
   apply the core/interface structure function ‘identify required structures from defined equivalences & differences’ to ‘find a requirement/rule connecting “particular animal” and “mammal”’
      this applies a useful core/interface structure function to this specific problem
      why is this useful? bc:
         the problem is:
         specifically to ‘find out if particular animal and mammal are related’
         generally to ‘find out any other rules or other requirement structures that can be inferred’
         so identifying useful core/interface structure functions relevant to these intents is useful, and fitting them to the problem/solution structures is even more useful
         these functions fulfill functions like problem-solving intents & other functions specific to this problem, so they are inherently useful, even if not to this specific problem
         ‘connect definitions by equivalence’ fulfills a ‘connect’ core interaction function
         ‘find limit structures of connection rules' fulfills a ‘filter the solution space’ problem-solving intent function
         once you know these specific functions would be useful, you can direct your interface query to find/derive/generate those functions, so this is another way of building an interface query, making it a solution automation workflow

find/derive/generate problem structure that would produce a solution to a problem in another system
if a solution structure with a particular attribute/function is required, find/derive/generate a problem structure like a problem system that would produce that solution structure in another system & test it in the original problem system
find/derive/generate a system with reasons/causes to generate a structure with the attribute/function, and which uses the structure for a similar cause/intent
example: for the ‘find a prediction function’ problem, this would involve finding a similar data set & using a successful solution function for that data set, similarity based on interface structures like cause or variable interactions or change types

apply intent interface specifically to derive specific problem-solving intents for a specific problem type that all problems can be converted to, intents that would be useful in solving the problem
example: deriving the intent of ‘reducing variables’ as a useful problem-solving intent for the ‘find a prediction function’ problem involves applying the definition of concepts like noise/outliers as an indication of irrelevant variables
   ‘reducing variables’ could then be an intent in a default interface query connecting the problem/solution for the specific problem type of ‘find a prediction function’, after converting a problem to a problem of ‘finding a prediction function’
generalization: ‘reducing variables’ would be relevant specifically in ‘reducing variables to unique change types’, which is a useful structure, so applying useful functions like ‘reduce’ to important problem structures like ‘variables’ and connecting those functions with useful structures like ‘unique change types’ is a generalization of this workflow

apply core interaction functions (like ‘reduce’, ‘connect’) and other function types (like ‘abstract’) and other useful structures to all relevant structures of the problem space to find useful changes to relevant problem structures that would reduce the problem of fulfilling problem-solving intents for those structures
example: applying ‘reduce’ to a ‘variable’ structure in the ‘find a prediction function’ problem into its components/inputs/attributes/generator may make useful structures like ‘structural similarities’ between relevant structures like ‘variables’ more obvious so they can be ‘reduced’ into one variable like a ‘type’ for relevant specific problem-solving intents like ‘reduce dimensions’ or ‘feature engineering’

identify the maximally different functions fulfilling a ‘core interaction-interface’ function (like ‘reduce change types’) from existing functions to begin a search for new solutions if existing solution functions produce errors
combinations of core interaction functions & interface structures would be likely useful in solving problems
   examples: ‘filter cause structures’, ‘connect interaction layers’, ‘sort useful structures’
this function type connects core interaction functions with interface structures, similar to interface functions like ‘find a structure in a structure’, or interim functions like ‘organize’ or ‘predict’
the difference in this function type is that these functions are likelier to be useful than other function types like general functions, core interaction functions which must be combined in a structure in order to be useful, or interface functions which are likely to require their own interface query
this function type is similar to problem-solving intent functions, interim functions, & interface queries, and may be able to be used as a substitute of some interface queries
generalization:
   after generating the set of possible useful interface queries to solve a problem, identify the emergent functions that are the most often required in the interface queries, to identify new or temporarily/conditionally useful function interaction levels & their metadata (why theyre useful, what is required for them to be useful, useful variants, etc)

find cross-interface structures (like the ‘intersection’ of ‘structures’ and ‘causes’ and ‘patterns’ of ‘variable interactions’) that interact with important problem structures that are determining for the success of a solution in various error type conditions
example: for the ‘find a prediction function’ problem:
   if a function has an error type of ‘false similarity’ (with different cause), the actual cause is different than the assumed cause allowing selection of that solution, so structures of variable interactions & causes would be useful in filtering out these solutions
   ‘variable interactions’ are an important structure for the ‘find a prediction function’ problem, so applying interface structures to this important structure can identify useful structures for building a robust solution to error types
   other important structures include the following, but ‘variable interactions’ are particularly important, as theyre the highest variation structure that is adjacent to the solution format (‘a prediction function’) & require fewer non-standard assumptions than function formats (subsets/alternate/component/conditional)
      input structures: data points, variable ranges, data types
      interim structures: data subsets, function filters/requirements
      output structures: subset/alternate/component/conditional functions
   functions like the following would identify useful structures of variable interactions & other interface structures that would determine success under various error type conditions
      find multiple alternate functions that follow variable interaction patterns more adjacently than the original line or better align with variable interaction causes
         apply changes to data set to find adjacent data sets with clear regression lines

change inputs/outputs to solve a different problem or change the sequence/structure of problems to be solved
example: rather than solving the initial problem to connect the original problem with a solution, solve a problem that is one-step closer to the solution & solve for a solution that is one-step away from the original solution, then apply changes to the inputs/outputs of that solution until it fits with the original problem/solution
   rather than solving the problem of ‘find a prediction function’ for original independent variables, solve the problem of ‘find a prediction function’ for aggregate variables (like types that summarize the original variables), because an alternate intent of ‘predict the data’ is ‘summarize the data’, so starting from a summary as an input is a step closer to the original solution format, which is a prediction (or summarization) function
   independent variables of data set=>summarizing variables like types or aggregates or compressions=>prediction/summarization function for dependent variables
   once you have this ‘inner’ solution, fit it to the original problem/solution by applying changes to the ‘inner’ solution
   apply changes to the summarization function of the summarized independent variables until it acts as a summarization function of the original independent variables that can predict the dependent variable
   another example would be to change the dependent variable predicted (find a prediction function that predicts z instead of y) then apply changes to that solution until it predicts y
   another example would be to abstract the inputs/outputs and solve for that prediction function instead, then applying specifying structures to the general solution, until it solves for the original problem that is an example of that generalization
workflow fit: this is a generalization of workflows that change inputs/outputs to solve a different problem, or solve a different sequence/structure of problems

identify alternate interchangeable structures that form an interchangeable solution to a problem in some condition, to cover as many conditions as possible
example: an ‘explanation’, ‘description’, ‘generator/cause’, ‘compression’, and ‘summary’ are alternate structures that can replace/approximate a ‘prediction function’ for the ‘find a prediction function’ problem, so if those can be solved for more quickly than a ‘prediction function’, they may be approximate/temporary/conditional substitutes for the ‘prediction function’ solution format
workflow fit: this is similar to the ‘find an approximate solution’ workflows, but involves applying the analysis to interchangeable structures in general & to as many conditions as possible to approximate/replace the original solution format

find/derive/generate ‘counterintuition’ & other ‘complexity’ structures that a solution-finding method should be able to handle & their associated difference structures from error & error-causing structures, using cause as a useful structure to find other relevant info that can be used to filter the solution space or differentiate between solutions/errors
example: distorting input so its maximally distorted but should still be identifiable as a category label in a categorization problem, and connecting it to differences from error structures (structures that would result in output of the incorrect or unknown label), or producing/expanding those differences in the input
‘Alternate generative functions’ of a species (like an agent building an artistic representation of a species) could produce ‘structural similarities’ resulting in an ‘unknown’ label error, so identifying features indicating alternate generative functions would be important to include in the solution-finding method (differences between a ‘dog’ and a ‘drawing of a dog’)
differences from structures of complexity like ambiguities would also be required to identify, as well as alternate feature sets that could differentiate between labels when some features are missing or unidentifiable
the highly distorted image isn't an error (it would be a complexity structure) but structures differentiating it from errors & errors that happen to also be complexity structures would produce a more robust solution-finding method, so the solution-finding method would have to included those differentiating structures
a ‘photo of a cat with a cartoon in it’ would be differentiable from a ‘photo of a cartoon of a cat’ by features like natural vs. agent-generated randomness & natural vs. agent-generated detail, so the solution-finding method would need to be able to identify those structures
   this means the interface query would include ‘find randomness structures’ and ‘find detail structures’ and ‘find agency structures’ as calls to find/derive/generate functionality fulfilling those intents
by generating the distortions, we start by knowing the cause of the distortions (‘an agent drew a cartoon’), and the related objects of those causes (‘human error’, ‘limited time or attention span leading to lack of detail’)
   this means we know what features would differentiate these distorted inputs from error inputs of various types (incorrect output label, unknown output label), so error structures & error causes should be more identifiable given the extra info we have about solution structures that happen to be complex

the interface query is basically ‘what questions need to be answered to solve this problem’-another variant would be ‘what information could allow this problem to be solved with this solution-finding function’
example: in the ‘find a prediction function’ problem, this would take the form of ‘finding what structures of information would have enough complexity to require a machine-learning algorithm to find a prediction function’
   the ‘find a prediction function for image categorization’ problem would require complexity in the form of structures like ambiguities, similar alternative opposites, distortions, & randomness, so images with those structures should be expected & could be derived from the problem statement
   a solution function that can determine the outputs from those inputs would have structures like ‘variable isolation’ (using ‘feature engineering’ functions) & ‘complexity reduction’ (using ‘generalizing’ functions) to connect those inputs/outputs
   if a solution-finding function cant solve the problem given the expected inputs, changes can be applied until it can connect the expected inputs with the outputs
   this means ‘the solution-finding method requires the referenced ‘variable isolation’ and ‘complexity reduction’ structures, to resolve the ambiguities & other complexity structures requiring the solution-finding method in common image categorization data sets'
   from the typical complexity & other problem-causing attributes of the problem, which would require using this solution-finding method (given the method intents like ‘find a prediction function’), we can derive the structures the solution-finding method would need
   all that is required to use this workflow is the problem statement ‘find a prediction function to categorize images’ and the solution format ‘categorization labels’, from which the structures required for the method can be derived given the implied complexity of the problem
   this applies the logic interface to derive implications & requirements as well as the concept interface to derive complexity structures

apply various alternate formats like sequences, preceding/succeeding sequences, & adjacent subsets, & defining values like extremes as inputs to prediction functions, to predict the adjacent/next item in a structure having relevance by adjacence/order (like a sequence of y-values for an x-value sequence)
example: rather than ‘trying to predict a line’, the problem can be a problem of ‘trying to predict the likelihood of a value, given the preceding values’ and ‘trying to predict whether the y-value sequence is likely given the prediction functions that succeed at predicting the next value’
   predicting an initial value from the following values, predicting an adjacent value from neighboring values, and predicting local from global values are examples of predictions that can be made by applying prediction functions to find a likely prediction function
generalization: this can be generalized to applying prediction functions to predict various interaction structures, predict which functions will be useful, predict important variables, and other structures required by a particular workflow
another variant would be to ‘apply probability & structure interfaces so that from structures that can be verified, identify probability of other structures until there's a structural interaction that cant be verified with some degree of certainty’
   example: for the ‘find a prediction function’ problem, given that there's a structure of ‘many change types’ in a parabola as opposed to a line (one change type, as in constant/charged change), what's the probability of a cycle structure or intersection with zero in the same function (how often do ‘many change types’ occurring in a parabola defined locally occur with a cycle structure defined elsewhere in the function)
this is only applicable in cases where the structure being predicted has relevance to the input structure (values in a continuous function can be connected in a sequence structure or adjacence structure like a subset)

solution automation workflows can be derived from core structures like combinations, sequences, and variables & interface structures applied to these core structures like inputs/outputs, interactions, & types

### Example

‘combination’ structures go with the workflow ‘build a solution out of components’, where components are interface structures that can be combined to create a solution
generalization:
   this can be generalized to ‘find the core structures of a system, and apply interface structures to those core structures, then fit these applications to fulfill an interaction function of problem/solution structures’

identify causes like inputs/requirements of useful structures (like a ‘question that triggers a useful structure like an optimization’), & connections with useful structures (like systems where useful structures are default), & system context structures that allow/incentivize useful structures to develop or don't prevent useful structures from developing (like a ‘lack of limits’), and apply those structures as the adjacents/inputs to finding useful structures or the generative structures of useful structures
alternatively, apply the definitions of useful structures & their metadata, like that a useful structure is defined as:
   having a structural alignment with an intent, making it useful for that intent
   existing in a space with variation, allowing for the existence of non-useful structures that make it useful by comparison, like the existence of alternative sub-optimal routes
   developing in a system where the system's existence is only achievable by developing a better way to fulfill an intent, incentivizing development of useful structures

apply solution structures that fulfill one problem-solving intent (like ‘preventing a problem’ or ‘solving a related problem’) to another problem-solving intent (like ‘fixing a problem’)

### Example

preventative solutions like vaccines have a solution success cause (using the immune system to prevent infection) that allows for re-use across other problem-solving intents such as fixes (like immunotherapy treatments)
   the ‘golden rule’ draws attention useful ‘preventative’ objects like empathy, but can also be used for other problem-solving intents like ‘restitution’ (fixing a crime), by connecting criminals/victims in other ways than empathy thought experiments (like trading criminal/victim positions, progressively applying more punishments rather than applying the same crime, connecting criminals with other victims of the same crime rather than their victim, etc)
   the reason the ‘preventative’ solution works is its interaction with ‘empathy’ or the ‘immune system’, and this cause can be re-applied in other problem-solving intent solution structures than ‘prevention’
generalization: this can be generalized to re-applying any problem/solution structures across different problem/solution variables (like different problem-solving intents) that have an important structure in common (like ‘success cause’), indicating there is reason to re-use one structure in another context

apply useful structures (like opposite structures) once applied to interfaces to fulfill functions of relevant types (like problem-solving intents, core interaction functions, interim functions, general functions) & organize these ‘useful structures for function types’ to find other useful structures connecting the useful structures (like useful structure sequences, hubs, overlaps, symmetries) in the ‘useful structure network’
example: with the ‘find a prediction function’ problem, the function might be verifiable as not a shape, a set of subset or conditional functions, a linear function, & other solution formats
   this is applying the ‘opposite’ structure to various difference types in solution format structures to fulfill the ‘filter solution space’ problem-solving intent, applied to various interfaces (‘opposite’ applied to ‘potential’ interface to produce ‘conditional alternative functions’)
   another example is how the ‘reduce’ function applied to ‘distance’ or ‘difference’ structures is a useful structure for the ‘connect’ function
‘format a problem in terms of an interface query that can be fulfilled with functions on this function type network or useful structures on the useful structure network to reduce computations required’ is a solution automation workflow that can use either of these networks once defined

calculate how much certainty can be determined with input info & apply that as a filter of the solution space & the solution format
example: with the ‘find a prediction function’ problem, the function may only be determinable within a certain range of alternative functions or within a certain parameter range, which may form a solution format of an area rather than a line/curve
knowing that only so much certainty in a solution can be derived with given inputs, the solution space can be filtered with an interface query connecting to that certainty structure instead of the original solution structure

find/derive/generate specific structures that are useful for specific problem-solving intents, general/core/interim function intents, or interface query intents, to implement those intents automatically
this involves identifying the cause of useful structures' usefulness & applying as a generative function

### Example

specific structures like ‘maximizing differences’ and ‘input-output sequences’ that are useful for problem-solving intents like ‘filter solution space’ & ‘connect problem/solution’, and other function intents be of the useful structures they generate like ‘adjacence to inputs of function intent’
   maximized differences are more adjacent to the input of ‘identify/filter’ functions & may reduce the work required by those functions to reach the output
      input-output sequences provide default possible solution or solution component structures to reduce the work of filtering the solution space, making the input to the ‘filter solution space’ function more similar to its required output (a reduced set of solutions)
      useful structures can be found/derived/generated by which structures create differences (like a difference in the form of a ‘reduction’ in possible solutions) that happen to be useful for various required intents (like ‘avoid errors’ or ‘identify difference’)

derive functions connecting function interaction levels (general, core, interim functions) and all the routes on the function network that are particularly useful for a specific function that solves a problem, then identify the average implementation & its parameters to define a standard function to solve that problem (fulfill the specific function) which can be adjusted as needed for varying intents
example: ‘remove similarities for comparison’ and ‘standardize to emphasize differences’ are useful connecting paths on the function network for the ‘find a prediction function’ problem (or the ‘predict’ interim function) which can also be formatted as a path on the function network

apply ml with useful structures for a problem-solving intent (like ‘generate code for a general function automatically’) that combines specific features into general features to combine specific structural functions (‘combine’, ‘sort’, ‘reduce’) to generate general functions (‘filter’, ‘identify’, ‘standardize’)
the reason ‘find a prediction function’ is a standard problem format that any problem can be formatted as, is bc its adjacent to an interim function ‘predict’ (‘find input-output sequence’, ‘identify causal variable’, ‘identify vertex variable’)
other standard problem formats are adjacent to other core/interim/general functions
generalization: this can be generalized to ‘find a solution with useful structures like ‘similarities’ in ‘inputs/outputs’ for a standard problem format like finding prediction functions that can be applied to the original problem once formatted according to the standard problem format’

apply interchangeable problem/solution & interface objects to each other, bc when there are interchangeable objects, that indicates they can be applied to each other in a useful way

### Example

variables/functions are interchangeable formats, which can be applied to each other to generate useful objects (‘variables of functions’ like ‘inputs/outputs/intents’, and ‘functions of variables’ like ‘determining/generating/causing’)
   find/build/apply can be applied to generate interim functions & common intents (‘find a build method’, ‘apply a find method to derive a build method’)
   applying problem-solving intents to each other can direct the design of interface queries fulfilling each intent ‘filter solution space’ of problem of ‘finding other problems to solve’
   applying specific problem formats which any problem can be formatted as (‘find a prediction function’, ‘apply sorting algorithm’) can be applied to each other
   core interaction functions can be applied to each other (‘reduce connections’, ‘sort reductions’, ‘combine sorts’)
these interchangeable objects tend to be on the same interaction level which can mean they are different useful variants of a core underlying base object, with overlapping definitions, and applying them to other objects on the same interaction level can produce more gains for an intent

identify useful structures for sub-intents of an interface query to use as default structures
example: for a sub-intent of ‘find an example’, structures of ‘specificity’ are more useful bc theyre ‘more adjacent to attributes of inputs’ of the sub-intent, ‘more adjacent to input attributes’ being a useful filter for useful structures
generalization: this can be generalized to ‘find all the interface & problem/solution structures of useful structures’, which would include ‘useful filters’ of useful structures for the ‘filter solution space problem-solving intent’

identify the structures with highest impact on solution success
example: in the ‘find a prediction function’ problem, this would include standard ‘contributing variables’ & ‘variable interactions’, but also ‘function structures’ like ‘averages’, ‘continuity’, ‘change rate patterns’, ‘waves/peaks/inflection points’
   these have high impact on solution success bc theyre ‘high variation’, ‘represent a standard’, ‘reflect the output of relevant variables like exponents or patterns’, are ‘relevant inputs like function component structures’, or are defined to be useful ‘patterns are defined to represent an abstraction of a change type’

identify the complete structures in a problem space & format the problem in terms of the complete structures for solution metrics like accuracy/robustness
example: variables aren't a complete structure until some understanding rules are injected about their interaction structures such as cause & relationship to other variables, the context in which they are variable/constant, and their associated change types

derive which interface structures (like combinations/subsets) are relevant to useful structures (like variable interactions) using insight rules (like that ‘adjacent features are likely to be dependent’) & comparing possible usefulness structures
example: how to derive ‘combinations’ of ‘variable interactions’ as useful structures, given the insight rule ‘adjacent variables are likely to be dependent’
   ‘Adjacence’ is ‘similarity in position’, and structures that are ‘similar in position’ are easier to fulfill intents like ‘group’, so ‘combinations’ are an ‘adjacent’ structure of this structure
   the ‘combination’ structure also fulfills intents like ‘isolate’ for structures like ‘dependent variables’, and ‘isolating related objects’ or ‘isolating objects of a type’ are a useful function for various general/problem-solving/interim/core function intents
      given that it can be adjacently used for various known useful intents, it can be considered a useful structure (after comparing it to the adjacently useful intent ratio of other possible useful structures)
   workflow fit: this is similar to other workflows involving deriving useful/interface structures useful for other useful/interface structures or problem-solving intents, but with a filter for evaluating probability of usefulness compared to other structures

identify structures of determination (where once a structure is determined, the other structures dependent on it are also determined) & apply as ‘reduction’ structures of computation requirements in an interface query

generate maximally different perspectives to avoid over-incentivizing one perspective & its resulting error types, to apply as solution filters
example: in the ‘find a prediction function’ problem, maximally different perspectives would include:
   ‘find the right unique isolated variable interaction to equal the output variable’
   ‘check if the definition of objects is applicable’
      if a ‘variable’ concept is not applicable to a particular structure, it will generate errors

### Example

if the ‘sound’ variable is only measurable by ‘vibrations’, it might be handled incorrectly, miss all the variation within the ‘sound’ variable, miss the fact that the ‘sound’ variable can act as an interface, and be a poor predictor of ‘sound’ variation & metadata like inputs/outputs
   the ‘variable’ concept refers to a ‘unique change type’, but it leaves out the ‘related variable network’ structure that all variables are nodes in & other structures relevant to that ‘variable’ definition, and would misidentify ‘vibrations’ as a change-determining variable rather than an attribute of the ‘sound’ variable, bc it would miss their interaction in the ‘related variable network’ inherent to a complete ‘variable’ definition, where usually a limited structural definition of ‘variable’ as ‘unique change type’ is applied
in the ‘chihuahua/muffin’ class identification problem, adjacent features aren't isolatable bc they determine what adjacent features are possible (the structure of a skull determines what configurations of structures surrounding it are possible), but they are treated as isolatable (the correlation between bone/organs is treated as independent), whereas other variables are isolatable but are treated as one variable (damage to one eye/ear doesn't necessarily correlate with damage to the other)
this is bc there is no ‘requirement’ structure requiring that any damage to one side be reflected in the other (the inherent symmetry can be distorted), but there are structures that ‘can’ require that (causes of organ damage)
‘requirement’ structures can be checked for using attributes of adjacent structures (does the skull seem to have a firm structure or would it necessarily change if another feature was removed)
not all variables treated as isolatable are actually isolatable, but with missing data they might seem isolatable
these perspective can be filtered by which would have the most impact on the solution success (solution success impact, as a variable that can limit or enable solution success)

find difference causes of interface structures (like concepts) and apply structures of them to create various solutions to filter as an initial solution space
example: find the reasons why data set points might differ (randomness, indicative of change in the underlying interaction, variation within expected/valid variable ranges) and create combinations of these reasons to explain the data set, by adjusting which points are included in the ‘find a prediction function’ problem input, which are excluded bc of reasons like ‘random noise’
this is useful bc difference causes are a powerful structure in understanding why differences occur so they can be created/predicted as needed

find useful structures like units/ratios between change causes (reasons to change) vs. reasons not to change to justify changing a standard solution (like a linear function) to find an optimal solution (a better-fitting function)

### Example

the reasons to change may include reasons like that ‘a data point would be better predicted if the change is applied’
   the reasons not to change may include reasons like that ‘patterns of changes of other functions that avoided this change type performed better’ or ‘the data point is an outlier’
   structures like ratios between these change causes can be useful if each change cause contributes equivalent certainty so they can be treated like units
   this is useful bc change causes from a standard solution are a powerful structure to help optimize a solution—if there is a reason to change a structure, its likelier to be reflective of reality

find target solution structures that lead to problem-solving processes even if they don't solve the original problem, like a target position that leads to change in a direction toward the original intended solution, even if the destination isn't reached

find structures of difference between ‘false rewards’ & other useful error structures of falsehood & the error structures they correct to apply as structure to fulfill the ‘error-correcting’ problem-solving intent
usually real rewards can be found to incentivize finding/generating/deriving a solution if its correct, so this shouldn't be necessary, but it can be more efficient than identifying/using real rewards to incentivize a solution/optimization

find the structures of primary default interface structures that are most useful across interface queries & workflows & apply those as default components
example: change+direction, priority+potential field, variable+concept type are examples of structures of interface structures, but some in particular are more useful than others, like ‘perspectives’ (filter with priorities) be they fulfill structures of usefulness like ‘capturing high variation’ and ‘reducing complexity’ and ‘applying importance structures’ which are useful for various interim & core functions like ‘find important objects’ and ‘understand a system quickly’ and ‘find hub variables’, so apply these metrics as filters of these structures of primary interface structures
workflow fit: this is similar to other workflows involving finding useful structures, but specifically filters them by which are useful for fulfilling intents of interim/core functions that are commonly used in interface queries' sub-intents

combine a partially implemented interface query with gaps in implementation left for variation, where the sections implemented are known to be optimal for various sub-intents of the interface query
the pieces that are implemented can be on different interaction levels of the interface query
generalization:
   this can be generalized to other interactions between problem/solution structures which have clearly optimal implementations of sections of the interaction
   it can be generalized further to other structures than ‘partial subset’, such as known optimal ‘sequences’ of problem/solution interactions or known optimal ‘combinations’ of problem/solution interactions
simplification: this can be simplified to adding a variable, allowing variation in which subsets or other structures are implemented & which can be changed for various implementations

interface structures that are adjacent (immediately preceding/following) to a solution so as to be causative or indicative of a solution can be identified as predictors or generators or identifiers of solution structures
if there's a perspective, function, change, pattern, etc that is often found around solutions, those can be used according to their position as predictors/generators/identifiers
this is similar to ‘applying the solution as a symmetry or interface around which changes are applied while still qualifying as a solution’, but applying the solution as a base or center where other objects relevant to it are adjacent, which may or may not be solutions, as a merged interface structure involving a combination of multiple interfaces, although the surrounding structures may also qualify as solutions
   adjacence can be determined by number of steps separating the structures (for example, separating a question/perspective/useful structure & a solution), number of interface structures separating them, distance determined by some similarity metric, or other definition

find a structure (such as a perspective/function or network with nodes arranged by a certain distance or similarity metric) that would make solving a problem much quicker (or fulfilling another solution metric, like using available resources) and aim for that structure as the solution target to generate (so the problem becomes ‘generate this useful structure’ instead of ‘solve the original problem’)
for example, when a function network is organized by similarity in impact, its easier to see which nodes are higher impact
this can be extended by applying filters to find useful ‘solution-adjacent’ or ‘adjacently solution-finding’ structures that make a solution obvious or guaranteed/inevitable
   structures like a particular way of organizing a network by some distance metric can make solving a set of problems trivial, which makes it more useful than a network organized in a way that solves one problem, other things being equal
   structures that ‘make solving multiple problems trivial’ are useful targets for solution automation workflows, as a problem-solving intent of ‘find structures that make solving the problem trivial’

store the optimal interface queries associated with a particular solution automation workflow to convert the ‘build interface query’ task into a ‘find interface query in database’ task, or store generative functions to find the optimal interface queries if any are stored, or derive the interface query in a more efficient way than interface query design logic
generalization: can be generalized to associations between any problem/solution structures

identify structures of error structures & their interface structures like meaning, for use in ‘predicting structures’, which is an interim function, or ‘predicting error/solution structures’, which is a problem-solving intent
example: when an extreme set of errors of a particular type usually precedes finding an interface, that can be used to predict which error structures mean that ‘an interface is about to be found’

One skilled in the art, after reviewing this disclosure, may recognize that modifications, additions, or omissions may be made to the solution automation module 140 without departing from the scope of the disclosure. For example, the designations of different elements in the manner described is meant to help explain concepts described herein and is not limiting. Further, the solution automation module 140 may include any number of other elements or may be implemented within other systems or contexts than those described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component in this disclaimer is intended to be broadly construed as hardware, firmware, or a combination of hardware and software.

Certain user interfaces have been described herein and/or shown in the Figures. A user interface may include a graphical user interface, a non-graphical user interface, a text-based user interface, or the like. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1. A method optionally comprising relating solution automation & interface analysis implementation variables & components such as the following:
function types (general functions, interim cross-interface functions, core interaction functions, problem-solving intent functions, interface operation functions, vertex functions), including additional function types like:
useful structure-adjacent functions (like ‘reduce computation’ which is adjacent to problem-solving intents like ‘minimize cost of finding solution’)
useful structure interaction functions (like ‘convert between various useful formats, such as useful problem/solution formats’, like the problem format ‘find a prediction function’ and the solution format ‘regression’)
solution automation workflows & their useful structures (like ‘generative/differentiating variables’) & their implementation variables (like ‘variables of general useful structures’ and ‘interface structures of general useful structures’ and ‘interface structures of specific useful structures like function types’)
general useful structures (like ‘definitely incorrect structures’, ‘adjacent solution structures’, ‘recursive/reflective/interchangeable structures’, ‘alternative structures to random structures’)
variables of implementations of solution automation & interface analysis

2. The method of claim 1, wherein example component variables of solution automation & interface analysis include various function types, like ‘useful structure-adjacent functions’ & ‘useful structure interaction functions’.

3. The method of claim 1, wherein example component variables of solution automation & interface analysis (like ‘solution automation workflows’) include variables of these components (like ‘generative variables’) so they can be interacted with (identified/derived/applied/generated) as needed.

4. The method of claim 1, wherein example component variables of solution automation & interface analysis (like ‘solution automation workflows’) involve interface structures, including useful structures such as ‘definitely incorrect structures’.

5. The method of claim 1, wherein example variables of implementations of solution automation & interface analysis include ‘component position’, ‘component interactions’, ‘component variability/adaptability’, ‘component priority’, ‘required components’, & ‘useful structures’ of a particular implementation of solution automation & interface analysis.

6. A non-transitory computer-readable medium containing instructions that, when executed by a processor, cause a device to perform operations, the operations comprising relating solution automation & interface analysis implementation variables & components such as the following:
function types (general functions, interim cross-interface functions, core interaction functions, problem-solving intent functions, interface operation functions, vertex functions), including additional function types like:
useful structure-adjacent functions (like ‘reduce computation’ which is adjacent to problem-solving intents like ‘minimize cost of finding solution’)
useful structure interaction functions (like ‘convert between various useful formats, such as useful problem/solution formats’, like the problem format ‘find a prediction function’ and the solution format ‘regression’)
solution automation workflows & their useful structures (like ‘generative/differentiating variables’) & their implementation variables (like ‘variables of general useful structures’ and ‘interface structures of general useful structures’ and ‘interface structures of specific useful structures like function types’)
general useful structures (like ‘definitely incorrect structures’, ‘adjacent solution structures’, ‘recursive/reflective/interchangeable structures’, ‘alternative structures to random structures’)
variables of implementations of solution automation & interface analysis

7. The non-transitory computer-readable medium of claim 6, wherein example component variables of solution automation & interface analysis include various function types, like ‘useful structure-adjacent functions’ & ‘useful structure interaction functions’.

8. The non-transitory computer-readable medium of claim 6, wherein example component variables of solution automation & interface analysis (like ‘solution automation workflows’) include variables of these components (like ‘generative variables’) so they can be interacted with (identified/derived/applied/generated) as needed.

9. The non-transitory computer-readable medium of claim 6, wherein example component variables of solution automation & interface analysis (like ‘solution automation workflows’) involve interface structures, including useful structures such as ‘definitely incorrect structures’.

10. The non-transitory computer-readable medium of claim 6, wherein example variables of implementations of solution automation & interface analysis include ‘component position’, ‘component interactions’, ‘component variability/adaptability’, ‘component priority’, ‘required components’, & ‘useful structures’ of a particular implementation of solution automation & interface analysis.

11. A system comprising: one or more processors; and one or more non-transitory computer-readable media containing instructions that, when executed by the one or more processors, cause the system to perform operations, the operations comprising relating solution automation & interface analysis implementation variables & components such as the following:
function types (general functions, interim cross-interface functions, core interaction functions, problem-solving intent functions, interface operation functions, vertex functions), including additional function types like:
useful structure-adjacent functions (like ‘reduce computation’ which is adjacent to problem-solving intents like ‘minimize cost of finding solution’)
useful structure interaction functions (like ‘convert between various useful formats, such as useful problem/solution formats’, like the problem format ‘find a prediction function’ and the solution format ‘regression’)
solution automation workflows & their useful structures (like ‘generative/differentiating variables’) & their implementation variables (like ‘variables of general useful structures’ and ‘interface structures of general useful structures’ and ‘interface structures of specific useful structures like function types’)
general useful structures (like ‘definitely incorrect structures’, ‘adjacent solution structures’, ‘recursive/reflective/interchangeable structures’, ‘alternative structures to random structures’)
variables of implementations of solution automation & interface analysis

12. The system of claim 11, wherein example component variables of solution automation & interface analysis include various function types, like ‘useful structure-adjacent functions’ & ‘useful structure interaction functions’.

13. The system of claim 11, wherein example component variables of solution automation & interface analysis (like ‘solution automation workflows’) include variables of these components (like ‘generative variables’) so they can be interacted with (identified/derived/applied/generated) as needed.

14. The system of claim 11, wherein example component variables of solution automation & interface analysis (like ‘solution automation workflows’) involve interface structures, including useful structures such as ‘definitely incorrect structures’.

15. The system of claim 11, wherein example variables of implementations of solution automation & interface analysis include ‘component position’, ‘component interactions’, ‘component variability/adaptability’, ‘component priority’, ‘required components’, & ‘useful structures’ of a particular implementation of solution automation & interface analysis.
